(19) United States
(12) Patent Application Publication
(10) Pub. No.: US 2026/0011216 A1
(43) Pub. Date: Jan. 8, 2026

(54) ELECTRONIC GAMING SYSTEMS AND METHODS WITH SYMBOL COLLECTION

(71) Applicant: Aristocrat Technologies, Inc., Las Vegas, NV (US)

(72) Inventors: Eric Boese, Decatur, GA (US); Ronald Williams, II, Atlanta, GA (US); Eduardo Enriquez, Chicago, IL (US); Jae Yi, Alpharetta, GA (US); Alex Jagrowski, Dunwoody, GA (US)

(21) Appl. No.: 18/766,253

(22) Filed: Jul. 8, 2024

(51) Int. Cl. G07F 17/32; G07F 17/34

(52) U.S. Cl. CPC G07F 17/3267; G07F 17/3211; G07F 17/34

(57) ABSTRACT

An electronic gaming device that includes a memory and a processor is described. The processor is configured to, for a first play of an electronic game, cause a first qualifier symbol to be displayed on a first reel, cause one or more first output symbols to be displayed, and cause one or more first output amounts to be added to the first qualifier symbol. The processor is also configured to, for a second play of the electronic game, cause a second qualifier symbol to be displayed on a second reel while the first qualifier symbol remains displayed, cause one or more second output symbols to be displayed, and cause one or more second output amounts associated with the one or more second output symbols to be added to the first qualifier symbol and the second qualifier symbol.

### TECHNICAL FIELD

The field of disclosure relates generally to electronic gaming, and more specifically, to electronic gaming systems and methods with symbol collection.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Typical games use a random number generator (RNG) to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Upon initiation of play, the RNG randomly determines a game outcome and symbols are then selected which correspond to that outcome. Notably, some games may include an element of skill on the part of the player and are therefore not entirely random.

### BRIEF DESCRIPTION

In one aspect, an electronic gaming device including at least one memory with instructions stored thereon and at least one processor in communication with the at least one memory is described. The instructions, when executed by the at least one processor, cause the at least one processor to cause display of a plurality of reels for an electronic game, the plurality of reels including a first reel subset where qualifier symbols are eligible to be provided and a second reel subset where output symbols are eligible to be provided. The instructions also cause the at least one processor to, for a first play of the electronic game, cause a first qualifier symbol to be displayed on a first reel of the first reel subset, cause one or more first output symbols to be displayed on the second reel subset, and cause one or more first output amounts associated with the one or more first output symbols to be added to the first qualifier symbol. The instructions further cause the at least one processor to, for a second play of the electronic game, cause a second qualifier symbol to be displayed on a second reel of the first reel subset while the first qualifier symbol remains displayed on the first reel subset, cause one or more second output symbols to be displayed on the second reel subset, and cause one or more second output amounts associated with the one or more second output symbols to be added to the first qualifier symbol and the second qualifier symbol.

In another aspect, at least one non-transitory computer-readable storage medium with instructions stored thereon is described. The instructions, in response to execution by at least one processor, cause the at least one processor to cause display of a plurality of reels for an electronic game, the plurality of reels including a first reel subset where qualifier symbols are eligible to be provided and a second reel subset where output symbols are eligible to be provided. The instructions also cause the at least one processor to, for a first play of the electronic game, cause a first qualifier symbol to be displayed on a first reel of the first reel subset, cause one or more first output symbols to be displayed on the second reel subset, and cause one or more first output amounts associated with the one or more first output symbols to be added to the first qualifier symbol. The instructions further cause the at least one processor to, for a second play of the electronic game, cause a second qualifier symbol to be displayed on a second reel of the first reel subset while the first qualifier symbol remains displayed on the first reel subset, cause one or more second output symbols to be displayed on the second reel subset, and cause one or more second output amounts associated with the one or more second output symbols to be added to the first qualifier symbol and the second qualifier symbol.

In another aspect, a method of electronic gaming implemented by at least one processor in communication with at least one memory is described. The method includes causing display of a plurality of reels for an electronic game, the plurality of reels including a first reel subset where qualifier symbols are eligible to be provided and a second reel subset where output symbols are eligible to be provided. The method also includes, for a first play of the electronic game, causing a first qualifier symbol to be displayed on a first reel of the first reel subset, causing one or more first output symbols to be displayed on the second reel subset, and causing one or more first output amounts associated with the one or more first output symbols to be added to the first qualifier symbol. The method further includes, for a second play of the electronic game, causing a second qualifier symbol to be displayed on a second reel of the first reel subset while the first qualifier symbol remains displayed on the first reel subset, causing one or more second output symbols to be displayed on the second reel subset, and causing one or more second output amounts associated with the one or more second output symbols to be added to the first qualifier symbol and the second qualifier symbol.

### BRIEF DESCRIPTION OF THE DRAWINGS

FIG. 1 is an exemplary diagram showing several EGMs networked with various gaming related servers.

FIG. 2A is a block diagram showing various functional elements of an exemplary EGM.

FIG. 2B depicts a casino gaming environment according to one example.

FIG. 2C is a diagram that shows examples of components of a system for providing online gaming according to some aspects of the present disclosure.

FIG. 3 illustrates, in block diagram form, an implementation of a game processing architecture algorithm that implements a game processing pipeline for the play of a game in accordance with various implementations described herein.

FIG. 4A illustrates an example screenshot and/or interface of an electronic game with symbol collection, in accordance with the present disclosure.

FIG. 4B illustrates another example screenshot and/or interface of the electronic game with symbol collection shown in FIG. 4A, in accordance with the present disclosure.

FIG. 5 illustrates another example screenshot and/or interface of the electronic game with symbol collection shown in FIG. 4A, in accordance with the present disclosure.

FIG. 6 illustrates another example screenshot and/or interface of the electronic game with symbol collection shown in FIG. 4A, in accordance with the present disclosure.

FIG. 7 illustrates another example screenshot and/or interface of the electronic game with symbol collection shown in FIG. 4A, in accordance with the present disclosure.

FIG. 8 illustrates another example screenshot and/or interface of the electronic game with symbol collection shown in FIG. 4A, in accordance with the present disclosure.

FIG. 9 illustrates another example screenshot and/or interface of the electronic game with symbol collection shown in FIG. 4A, in accordance with the present disclosure.

FIG. 10 illustrates another example screenshot and/or interface of the electronic game with symbol collection shown in FIG. 4A, in accordance with the present disclosure.

FIG. 11 illustrates another example screenshot and/or interface of the electronic game with symbol collection shown in FIG. 4A, in accordance with the present disclosure.

FIG. 12 illustrates another example screenshot and/or interface of the electronic game with symbol collection shown in FIG. 4A, in accordance with the present disclosure.

FIG. 13 illustrates another example screenshot and/or interface of the electronic game with symbol collection shown in FIG. 4A, in accordance with the present disclosure.

FIG. 14 illustrates an example screenshot and/or interface of an electronic game with symbol collection, in accordance with the present disclosure.

FIG. 15 illustrates another example screenshot and/or interface of the electronic game with symbol collection shown in FIG. 14, in accordance with the present disclosure.

FIG. 16 illustrates another example screenshot and/or interface of the electronic game with symbol collection shown in FIG. 14, in accordance with the present disclosure.

FIG. 17 illustrates another example screenshot and/or interface of the electronic game with symbol collection shown in FIG. 14, in accordance with the present disclosure.

FIG. 18 illustrates another example screenshot and/or interface of the electronic game with symbol collection shown in FIG. 14, in accordance with the present disclosure.

FIG. 19 illustrates another example screenshot and/or interface of the electronic game with symbol collection shown in FIG. 14, in accordance with the present disclosure.

FIG. 20 illustrates another example screenshot and/or interface of the electronic game with symbol collection shown in FIG. 14, in accordance with the present disclosure.

FIG. 21 illustrates another example screenshot and/or interface of the electronic game with symbol collection shown in FIG. 14, in accordance with the present disclosure.

FIG. 22 illustrates another example screenshot and/or interface of the electronic game with symbol collection shown in FIG. 14, in accordance with the present disclosure.

FIG. 23 illustrates an example screenshot and/or interface of a transition from the electronic game shown in FIG. 14 to another electronic game with symbol collection, in accordance with the present disclosure.

FIG. 24 illustrates another example screenshot and/or interface of a transition from the electronic game shown in FIG. 14 to another electronic game with symbol collection, in accordance with the present disclosure.

FIG. 25 illustrates another example screenshot and/or interface of a transition from the electronic game shown in FIG. 14 to another electronic game with symbol collection, in accordance with the present disclosure.

FIG. 26 illustrates another example screenshot and/or interface of an electronic game with symbol collection, in accordance with the present disclosure.

FIG. 27 illustrates another example screenshot and/or interface of the electronic game with symbol collection shown in FIG. 26, in accordance with the present disclosure.

FIG. 28 illustrates another example screenshot and/or interface of the electronic game with symbol collection shown in FIG. 26, in accordance with the present disclosure.

FIG. 29 illustrates another example screenshot and/or interface of the electronic game with symbol collection shown in FIG. 26, in accordance with the present disclosure.

FIG. 30 illustrates another example screenshot and/or interface of the electronic game with symbol collection shown in FIG. 26, in accordance with the present disclosure.

FIG. 31 illustrates another example screenshot and/or accordance with the present disclosure.

FIG. 32 illustrates another example screenshot and/or interface of the electronic game with symbol collection shown in FIG. 26, in accordance with the present disclosure.

FIG. 33 illustrates another example screenshot and/or interface of the electronic game with symbol collection shown in FIG. 26, in accordance with the present disclosure.

FIG. 34 illustrates another example screenshot and/or interface of the electronic game with symbol collection shown in FIG. 26, in accordance with the present disclosure.

FIG. 35 illustrates another example screenshot and/or interface of the electronic game with symbol collection shown in FIG. 26, in accordance with the present disclosure.

FIG. 36 illustrates another example screenshot and/or interface of the electronic game with symbol collection shown in FIG. 26, in accordance with the present disclosure.

FIG. 37 illustrates another example screenshot and/or interface of the electronic game with symbol collection shown in FIG. 26, in accordance with the present disclosure.

FIG. 38 illustrates another example screenshot and/or interface of the electronic game with symbol collection shown in FIG. 26, in accordance with the present disclosure.

FIG. 39 illustrates another example screenshot and/or interface of the electronic game with symbol collection shown in FIG. 26, in accordance with the present disclosure.

FIG. 40 illustrates another example screenshot and/or accordance with the present disclosure.

FIG. 41 illustrates another example screenshot and/or interface of the electronic game with symbol collection shown in FIG. 26, in accordance with the present disclosure.

FIG. 42 illustrates another example screenshot and/or interface of the electronic game with symbol collection shown in FIG. 26, in accordance with the present disclosure.

FIG. 43 illustrates another example screenshot and/or interface of the electronic game with symbol collection shown in FIG. 26, in accordance with the present disclosure.

FIG. 44 illustrates another example screenshot and/or interface of the electronic game with symbol collection shown in FIG. 26, in accordance with the present disclosure.

FIG. 45 illustrates another example screenshot and/or interface of the electronic game with symbol collection shown in FIG. 26, in accordance with the present disclosure.

FIG. 46 illustrates another example screenshot and/or interface of the electronic game with symbol collection shown in FIG. 26, in accordance with the present disclosure.

FIG. 47 illustrates another example screenshot and/or interface of the electronic game with symbol collection shown in FIG. 26, in accordance with the present disclosure.

FIG. 48 illustrates another example screenshot and/or interface of the electronic game with symbol collection shown in FIG. 26, in accordance with the present disclosure.

FIG. 49 illustrates another example screenshot and/or accordance with the present disclosure.

FIG. 50 illustrates another example screenshot and/or interface of the electronic game with symbol collection shown in FIG. 26, in accordance with the present disclosure.

FIG. 51 illustrates an example method of electronic gaming with symbol collection, in accordance with the present disclosure.

### DETAILED DESCRIPTION

Described herein are systems and methods for electronic gaming with symbol collection. In the example embodiment, an electronic game is provided that includes a game mechanic where, if a qualifier symbol is provided (e.g., a LeprePig symbol) during a base game play, the qualifier symbol will collect and immediately award the value of any cash on reel (COR) symbols (e.g., symbols associated with an output amount displayed thereon) that are also provided during that play. In the example embodiment, qualifier symbols may be provided on a leftmost reel or a rightmost reel, while COR symbols may be provided on reels in between the leftmost reel and the rightmost reel. In some embodiments, qualifier symbols and/or COR symbols may be provided on any reels.

When a qualifier symbol or qualifier symbols are provided during the base game, a feature game (e.g., a free spin game) may be randomly triggered. If the feature game is triggered, the qualifier symbol or qualifier symbols, with any collected COR symbol values, are transferred into the feature game and locked into their reel position for the duration of the feature game. The qualifier symbol or qualifier symbols continue to collect the award values of any COR symbols that are provided during the feature game.

If a new qualifier symbol lands during the feature game, the new qualifier symbol locks into place and begins collecting the value of any new COR symbols that are provided during the feature game. Each new qualifier symbol that is provided during the feature game may randomly retrigger the feature game. The final value of the qualifier symbol or qualifier symbols is provided at the end of the feature game.

The technical problems addressed herein include at least one of: (i) inability of known systems to accumulate COR symbol values on multiple qualifier symbols during an electronic game while controlling RTP; (ii) inability of known systems to efficiently communicate accumulation of COR symbol values on multiple qualifier symbols; (iii) inability of known systems to efficiently communicate which symbols are eligible to be provided while reels are spinning; and (iv) inability of known systems to adjust reel strips in between spins of an electronic game based upon a number of displayed qualifier symbols and to control RTP.

The resulting technical effects and/or technical benefits achieved by this disclosure include at least one of: (i) ability to accumulate COR symbol values on multiple qualifier symbols during an electronic game while controlling RTP; (ii) ability to efficiently communicate accumulation of COR symbol values on multiple qualifier; (iii) ability to efficiently communicate which symbols are eligible to be provided while reels are spinning; (iv) ability to adjust reel strips in between spins of an electronic game based upon a number of displayed qualifier symbols and to control RTP; (v) displaying large quantities of complex information in a relatively small display area; (vi) communicating complex information with easy-to-understand animations on a display; (vii) clearly indicating when a player has entered a feature game; (viii) efficiently communicating different game rules for the feature game on the display during game play; and (ix) providing versatility as to which devices (e.g., EGMs, mobile devices, etc.) the games described herein may be played on because of the efficient display area designs described herein.

Various interface improvements are provided herein to efficiently and effectively communicate information. For instance, animations are provided between COR symbols and qualifier symbols to communicate that COR symbol values associated with the COR symbols are being added to the qualifier symbols. Further, at least during the feature game described herein, only certain symbols (e.g., qualifier symbols and COR symbols) are eligible to land. Accordingly, while the reels are spinning (e.g., and after the reels stop spinning), symbols that are eligible to be provided are highlighted (e.g., illuminated) in order to efficiently communicate which symbols are eligible to land. Further, symbols that are ineligible to be provided are greyed out in order to efficiently communicate which symbols are ineligible to land.

In some embodiments, reels used for the feature game are different from reels used for the base game. For example, in some embodiments, reels for the feature game may be stored with symbols that are eligible to be provided being illuminated thereon and symbols that are ineligible to be provided being dull. In some embodiments, dynamic determinations may be made for reels of the feature game as to which symbols are illuminated (e.g., eligible to be provided) and which symbols are dull (e.g., ineligible to be provided).

Example embodiments described herein may be provided in combination or in isolation to summarize and present game mechanics in a manner that improves the efficiency of computer systems (e.g., electronic gaming systems including electronic gaming devices). Each example system provides an improved user interface displaying a limited set of information to players, potentially within a small screen, such that players can more quickly understand the current status of the game and navigate to the next play of the game. The systems and methods provide improved display device functionality (e.g., on a gaming device) by providing multiple visual indicators that communicate game mechanics described herein to players. The systems and methods provided herein also improve display and device efficiency by eliminating the need for complex information pages describing game mechanics to players. Because of at least the easily-understood animations, symbols, and indicators displayed, the games described herein can be played and understood on a single screen substantially smaller than some of the EGMs described herein (e.g., a mobile device such as a cell phone), thus removing the need for multiple displays with complex information screens including lengthy text.

Further, different specific lookups may be utilized during game play described herein in order to properly provide qualifier symbols that accumulate COR symbol values while controlling RTP. Reel strips may be changed during the base game and/or the feature game described herein in between certain spins. For instance, reel strips may be selected for each spin based upon a number of qualifier symbols that are displayed (e.g., and will be held for a next spin in the feature game).

As an example, pluralities of reel strips may be stored in memory as being associated with a number of displayed qualifier symbols. Accordingly, for a next spin where one qualifier symbol remains displayed (e.g., is held) from a previous spin, a lookup may be performed for reel strips associated with one qualifier symbol being displayed and those reel strips may be used for the next spin. Further, say a second qualifier symbol is provided during the next spin. Then, for another subsequent spin, another lookup may be performed for reel strips associated with two qualifier symbols being displayed and those reel strips may be used for the another subsequent spin (e.g., and so forth). Because qualifier symbols accumulate COR symbol values across a plurality of spins in the feature game, the different reel strips are utilized depending on the number of qualifier symbols displayed in order to control RTP. As one example, reel strips associated with more displayed qualifier symbols may include more COR symbols thereon than reel strips associated with less displayed qualifier symbols (e.g., less COR symbol values being applied to more qualifier symbols may have a similar RTP to more COR symbol values being applied to less qualifier symbols).

In the example embodiment, an electronic gaming device is described that includes at least one memory with instructions stored thereon and at least one processor in communication with the at least one memory. The instructions, when executed by the at least one processor, cause the at least one processor to cause display of a plurality of reels for an electronic game, the plurality of reels including a first reel subset where qualifier symbols are eligible to be provided and a second reel subset where output symbols are eligible to be provided. The instructions also cause the at least one processor to, for a first play of the electronic game, cause a first qualifier symbol to be displayed on a first reel of the first reel subset, cause one or more first output symbols to be displayed on the second reel subset, and cause one or more first output amounts associated with the one or more first output symbols to be added to the first qualifier symbol. The instructions further cause the at least one processor to, for a second play of the electronic game, cause a second qualifier symbol to be displayed on a second reel of the first reel subset while the first qualifier symbol remains displayed on the first reel subset, cause one or more second output symbols to be displayed on the second reel subset, and cause one or more second output amounts associated with the one or more second output symbols to be added to the first qualifier symbol and the second qualifier symbol.

In some embodiments, the instructions further cause the at least one processor to cause display of an animation between the one or more first output symbols and the first qualifier symbol to communicate that the one or more first output amounts associated with the one or more first output symbols are being added to the first qualifier symbol.

In some embodiments, the instructions further cause the at least one processor to cause display of animations simultaneously between the one or more second output symbols and the first qualifier symbol and the one or more second output symbols and the second qualifier symbol to communicate that the one or more second output amounts are being added to the first qualifier symbol and the second qualifier symbol.

In some embodiments, the first reel subset includes a leftmost reel of the plurality of reels and a rightmost reel of the plurality of reels. In some embodiments, the second reel subset includes reels of the plurality of reels between the leftmost reel and the rightmost reel.

In some embodiments the instructions further cause the at least one processor to provide the electronic game for a number of plays, the number of plays including the first play and the second play. In some embodiments, the instructions further cause the at least one processor to randomly determine whether to increase the number of plays in response to at least one of the first qualifier symbol being displayed for the first play or the second qualifier symbol being displayed for the second play.

In some embodiments, the instructions further cause the at least one processor to, for a third play of the electronic game cause a third qualifier symbol to be displayed on one of the first reel of the first reel subset or the second reel of the first reel subset while the first qualifier symbol and the second qualifier symbol remain displayed on the first reel subset, cause one or more third output symbols to be displayed on the second reel subset, and cause one or more third output amounts associated with the one or more third output symbols to be added to the first qualifier symbol, the second qualifier symbol, and the third qualifier symbol.

In some embodiments, the instructions further cause the at least one processor to, after a last play of the electronic game, cause total output amounts accumulated for the first qualifier symbol and the second qualifier symbol to be provided, the total output amounts including the one or more first output amounts and the one or more second output amounts for the first qualifier symbol and the one or more second output amounts for the second qualifier symbol.

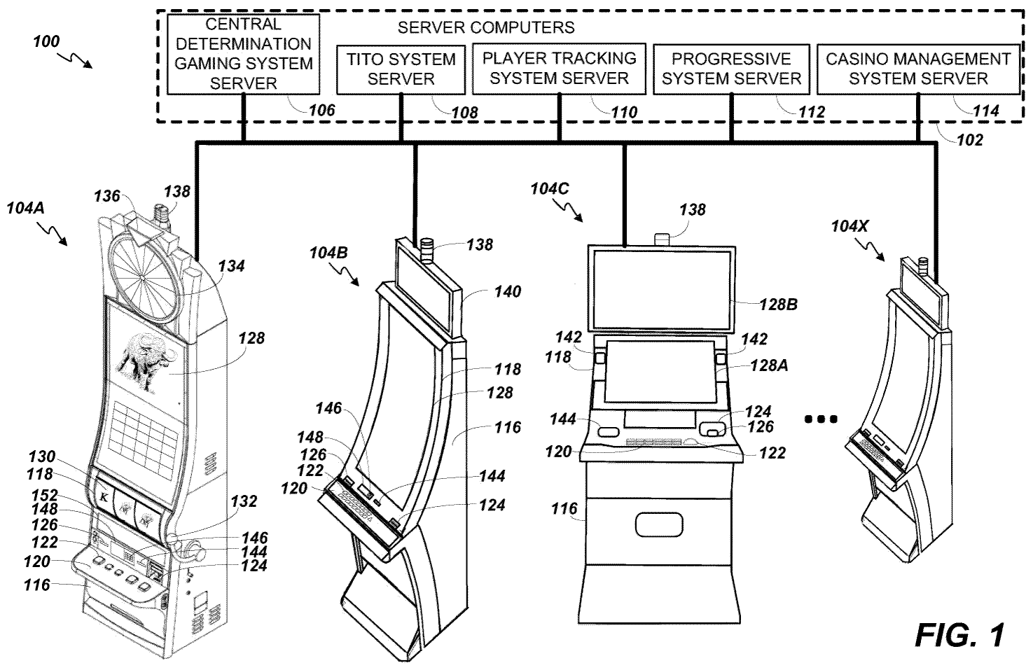

FIG. 1 illustrates several different models of EGMs which may be networked to various gaming related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementation, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

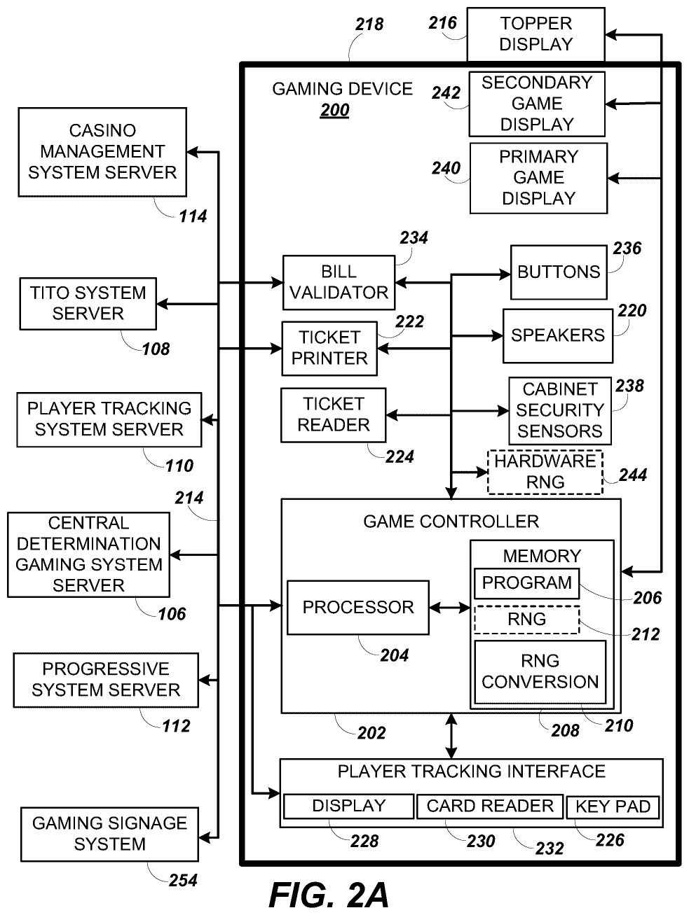

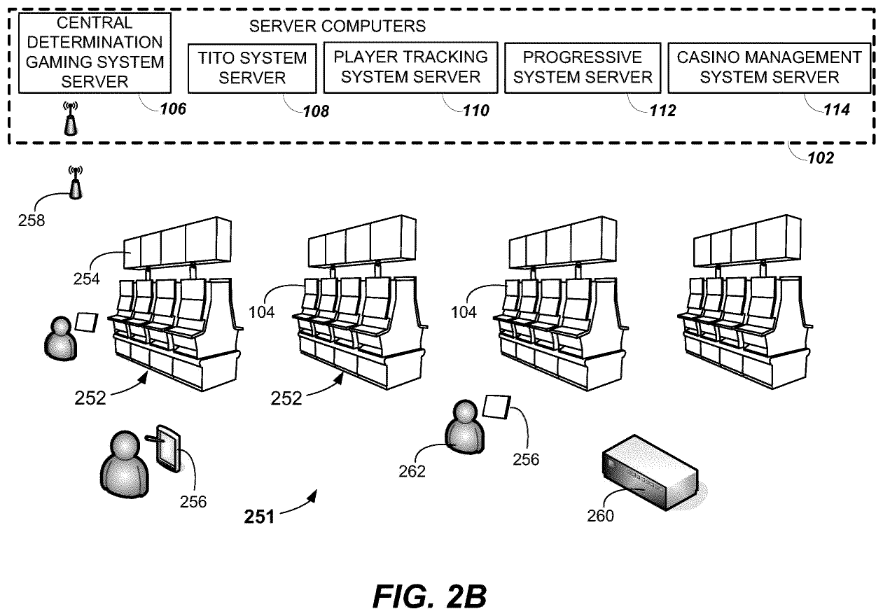

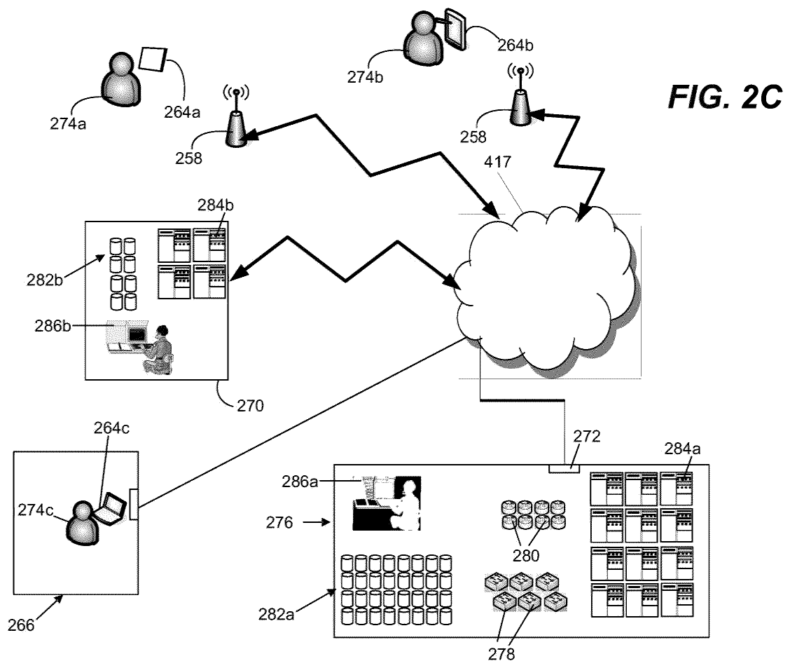

Many or all the above described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc™ model gaming device manufactured by Aristocrat® Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play or any other information or media desired by the game designer or operator. In some implementations, example gaming device 104C may also include speakers 142 to output various audio such as game sound, background music, etc.

Many different types of games, including mechanical slot games, video slot games, video poker, video black jack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2 also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g. amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 286a. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

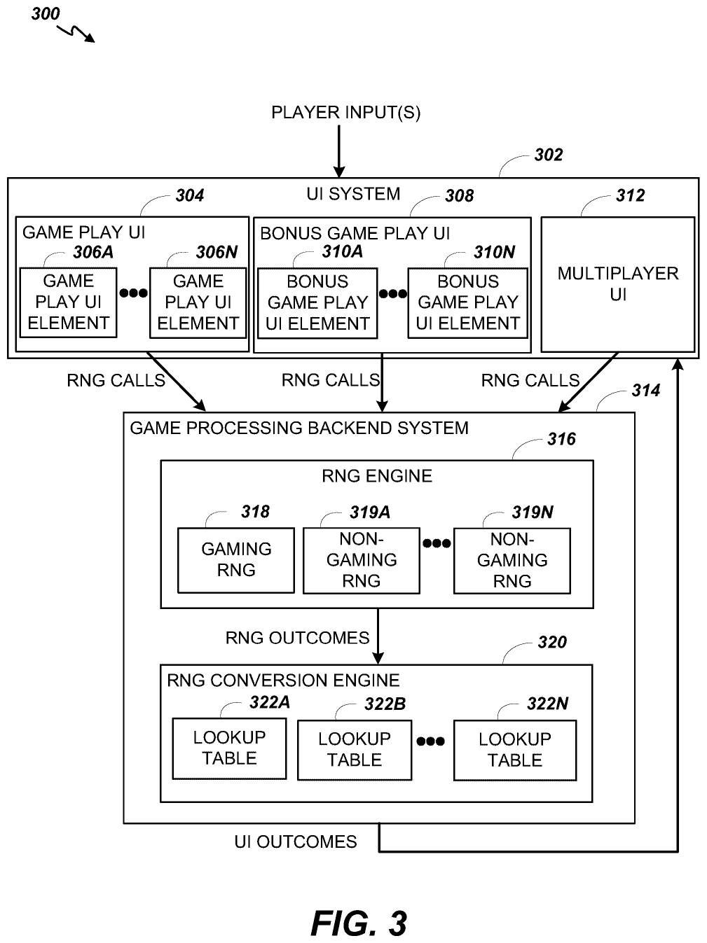

FIG. 3 illustrates, in block diagram form, an implementation of a game processing architecture 300 that implements a game processing pipeline for the play of a game in accordance with various implementations described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact with. The UI system 302 could include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more implementations, at least some of the game play UI element 306A-306N are similar to the bonus game play UI elements 310A-310N. In other implementations, the game play UI element 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could corresponds to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

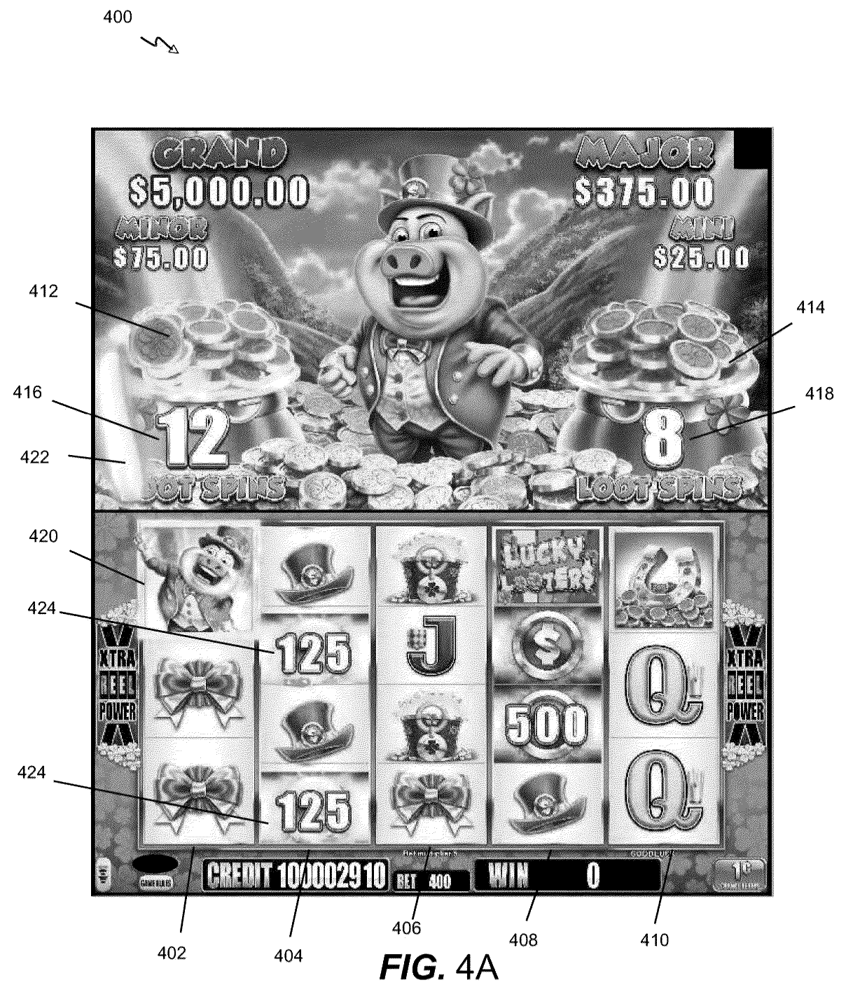

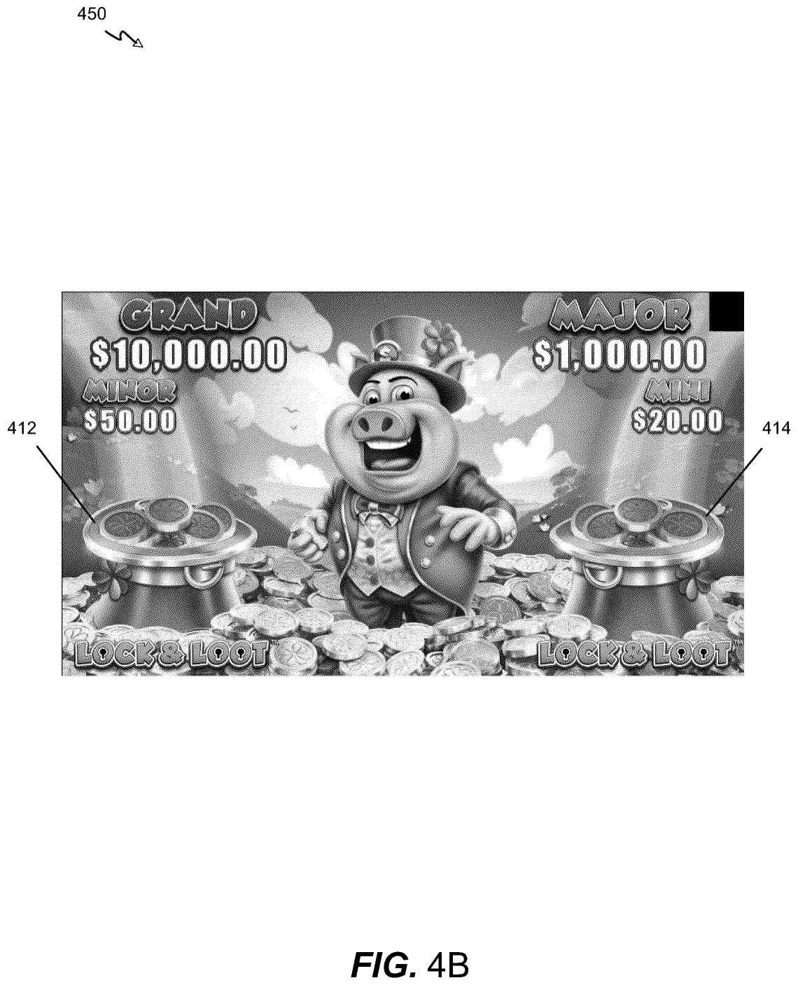

FIG. 4A illustrates an example screenshot and/or interface 400 of an electronic game with symbol collection, in accordance with the present disclosure. In the example embodiment, FIG. 4A shows a base game with symbol collection. As shown in FIG. 4A, reels 402-410 are provided. In the example embodiment, reel 402 and reel 410 are eligible to provide qualifier symbols while reels 404, reel 406, and reel 408 are eligible to provide COR symbols. Further, metamorphics 412, 414 are provided.

When a qualifier symbol is provided, an animation may be shown between the qualifier symbol and one or more of metamorphics 412, 414. A random determination may occur each time a qualifier symbol is provided as to which metamorphics 412, 414 a random determination will be made for triggering the feature game (e.g., a first random determination for which metamorphics 412, 414 may trigger the feature game for that spin (e.g., and therefore to which metamorphics 412, 414 an animation from the qualifier symbol will be shown) and a second random determination as to whether the randomly determined metamorphic(s) 412, 414 cause the feature game to be triggered).

In some embodiments, the number of spins associated with metamorphics 412, 414 may randomly increase (e.g., incrementally by one spin) during play of the base game. In some embodiments, after a play of the feature game, the number of spins associated with metamorphics 412, 414 may be reset to a predetermined and/or random amount of spins.

When the feature game is triggered, whichever metamorphic 412, 414 is associated with the feature game being triggered may be animated to communicate that the feature game is triggered. Further, each metamorphic 412, 414 is associated with a number of spins 416, 418. When the feature game is triggered, the number of spins associated with the metamorphic that is animated may correspond to the number of spins initially provided in the feature game (e.g., additional spins may be provided during play of the feature game).

In the example shown in FIG. 4A, reels 402, 410 are shown with less symbol positions than reels 404-408. For instance, reels 404-408 may include more symbol positions in order for more chances to land a COR symbol to be provided. In some embodiments, any number of symbol positions may be provided on any of reels 402-410.

As shown in FIG. 4A, a qualifier symbol 420 is provided on reel 402. Accordingly, an animation 422 is shown (e.g., a rainbow beam) between qualifier symbol 420 and metamorphic 412 to communicate that a random determination is being made as to whether a feature game will be triggered with number of spins 416. In the example embodiment, reels 402-410 stop one by one from left to right. In FIG. 4A, reel 402 and reel 404 have stopped spinning while reels 406-410 remain spinning. Notably, reel 404 includes two COR symbols 424 displayed thereon and COR symbol values associated with COR symbols 424 will be applied to qualifier symbol 420 at the end of the spin.

In some embodiments, such as the example shown in screenshot and/or interface 450 of FIG. 4B, the number of spins associated with metamorphics 412, 414 may not be displayed and/or metamorphics 412, 414 may not be associated with a number of spins.

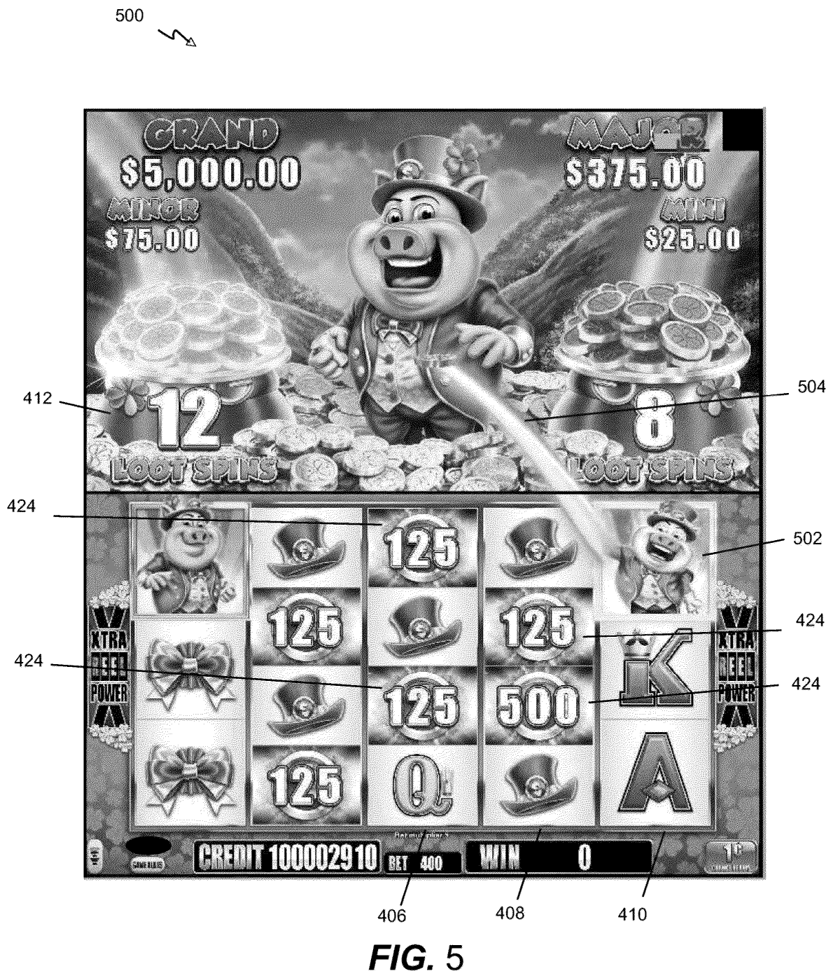

FIG. 5 illustrates another example screenshot and/or interface 500 of the electronic game with symbol collection shown in FIG. 4A, in accordance with the present disclosure. As shown in FIG. 5, reels 406-410 have now stopped spinning. Reel 406 includes two COR symbols 424 displayed thereon and reel 408 includes two COR symbols 424 displayed thereon. Further, a qualifier symbol 502 is provided on reel 410. Accordingly, an animation 504 is shown between qualifier symbol 502 and metamorphic 412.

In the example embodiment, when a COR symbol value from a COR symbol is applied to a qualifier symbol, the COR symbol from which the COR symbol value may change to a different display state to communicate that the COR symbol value associated therewith has already been applied.

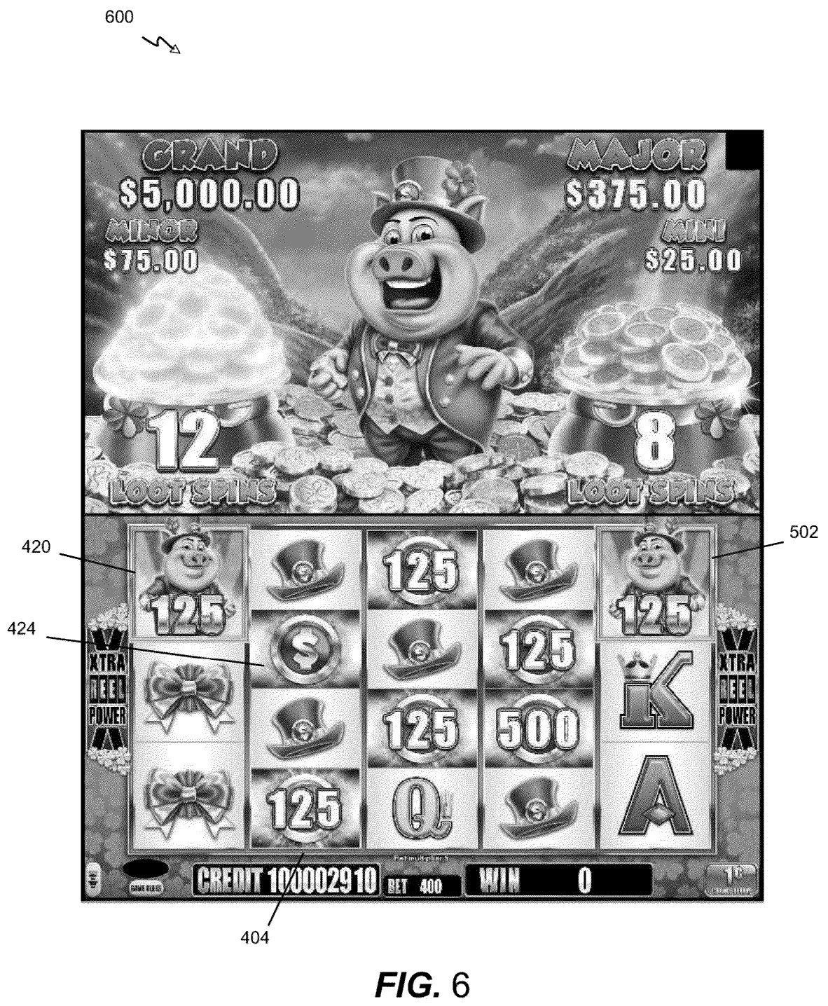

FIG. 6 illustrates another example screenshot and/or interface 600 of the electronic game with symbol collection shown in FIG. 4A, in accordance with the present disclosure. As shown in FIG. 6, a COR symbol value (e.g., 125) associated with a first COR symbol 424 on reel 404 has been applied to qualifier symbols 420, 502. Accordingly, the first COR symbol 424 on reel 404 has changed display state (e.g., to a $ symbol) to communicate that the COR symbol value associated therewith has been applied to qualifier symbols 420, 502.

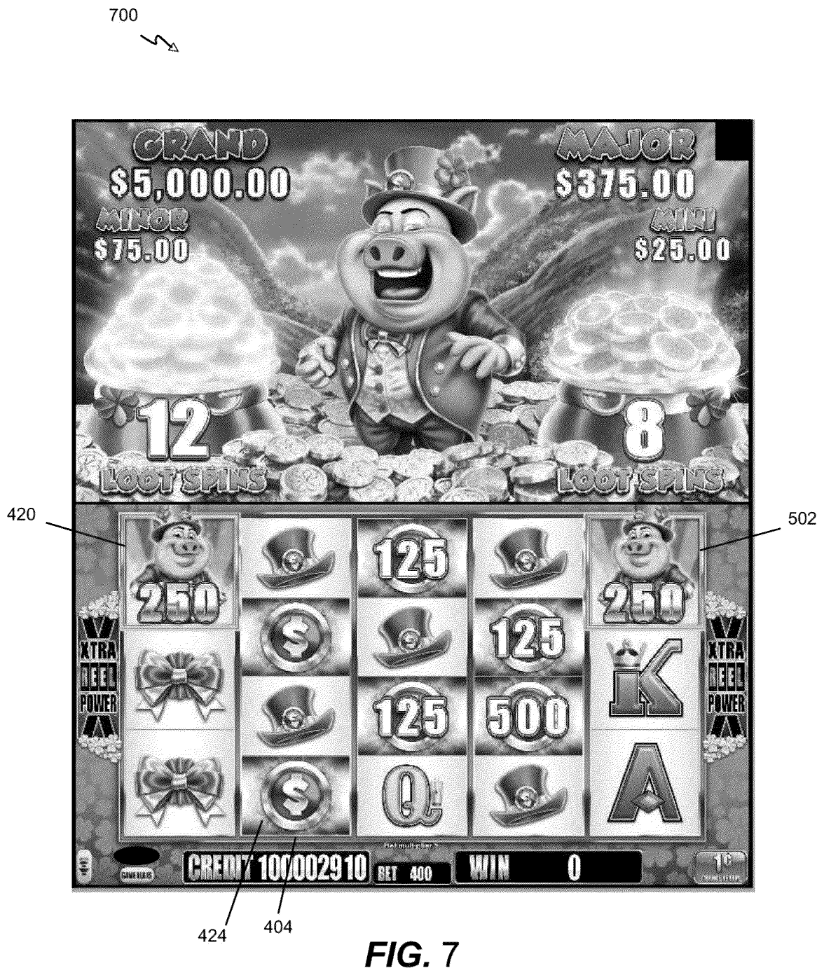

FIG. 7 illustrates another example screenshot and/or interface 700 of the electronic game with symbol collection shown in FIG. 4A, in accordance with the present disclosure. As shown in FIG. 7, a COR symbol value (e.g., 125) associated with a second COR symbol 424 on reel 404 has been applied to qualifier symbols 420, 502. Accordingly, the second COR symbol 424 on reel 404 has changed display state (e.g., to a $ symbol) to communicate that the COR symbol value associated therewith has been applied to qualifier symbols 420, 502.

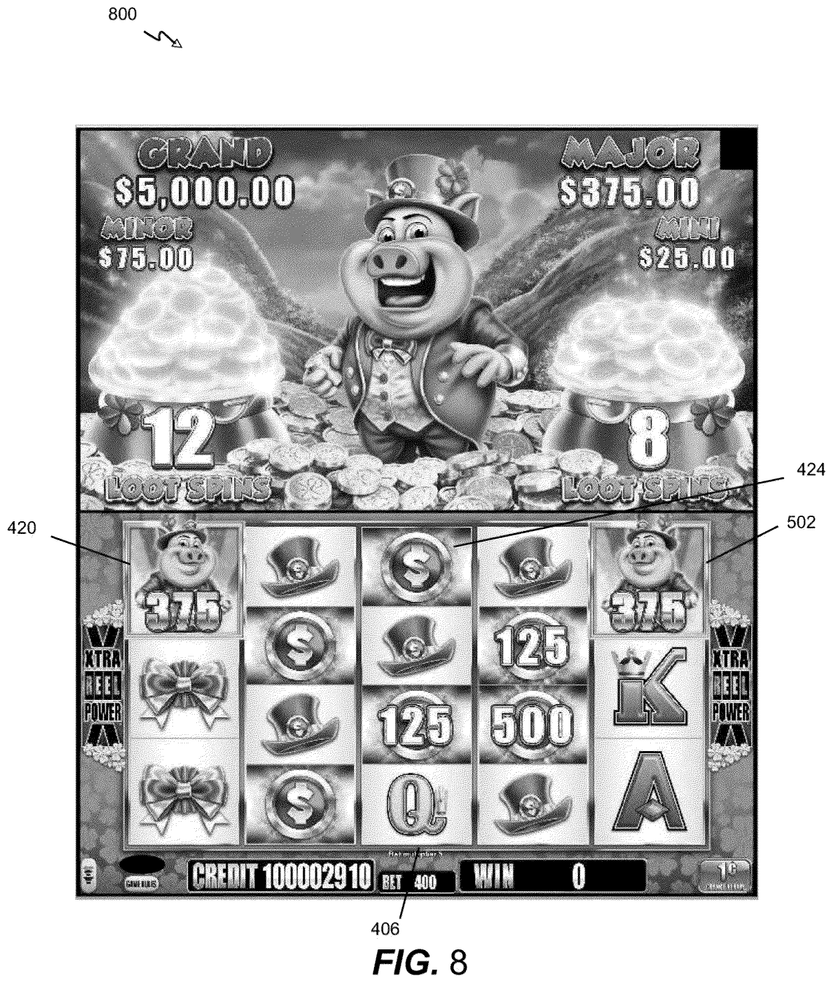

FIG. 8 illustrates another example screenshot and/or interface 800 of the electronic game with symbol collection shown in FIG. 4A, in accordance with the present disclosure. As shown in FIG. 8, a COR symbol value (e.g., 125) associated with a first COR symbol 424 on reel 406 has been applied to qualifier symbols 420, 502. Accordingly, the first COR symbol 424 on reel 406 has changed display state (e.g., to a $ symbol) to communicate that the COR symbol value associated therewith has been applied to qualifier symbols 420, 502.

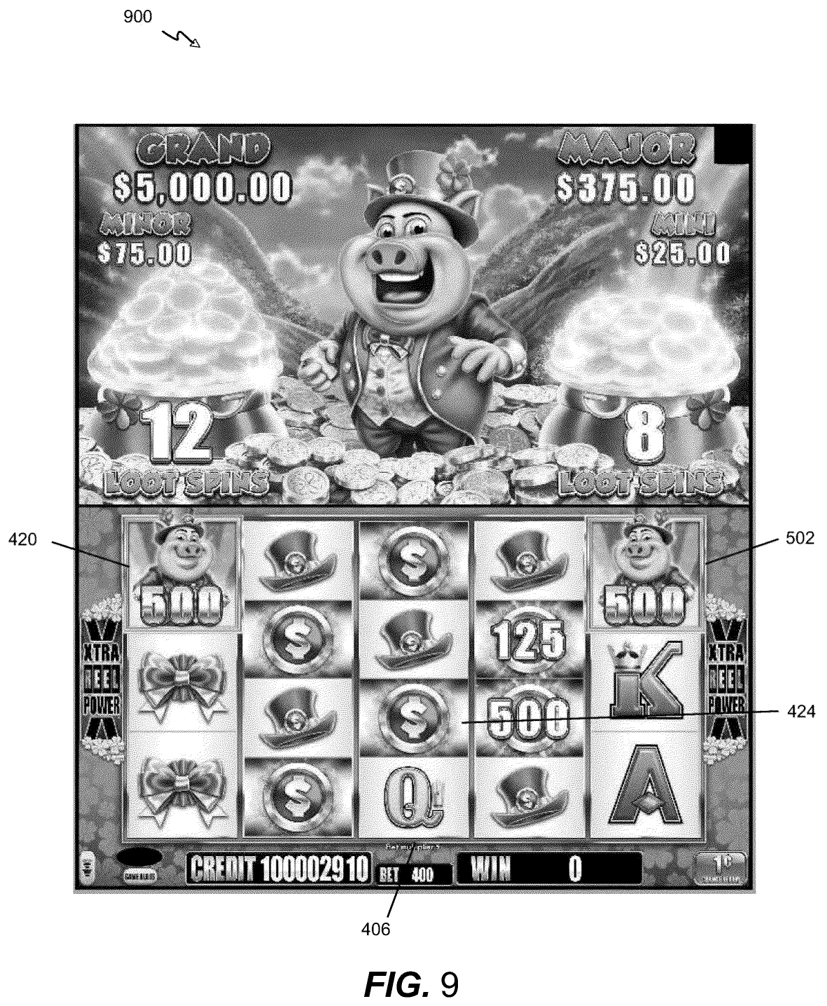

FIG. 9 illustrates another example screenshot and/or interface 900 of the electronic game with symbol collection shown in FIG. 4A, in accordance with the present disclosure. As shown in FIG. 9, a COR symbol value (e.g., 125) associated with a second COR symbol 424 on reel 406 has been applied to qualifier symbols 420, 502. Accordingly, the second COR symbol 424 on reel 406 has changed display state (e.g., to a $ symbol) to communicate that the COR symbol value associated therewith has been applied to qualifier symbols 420, 502.

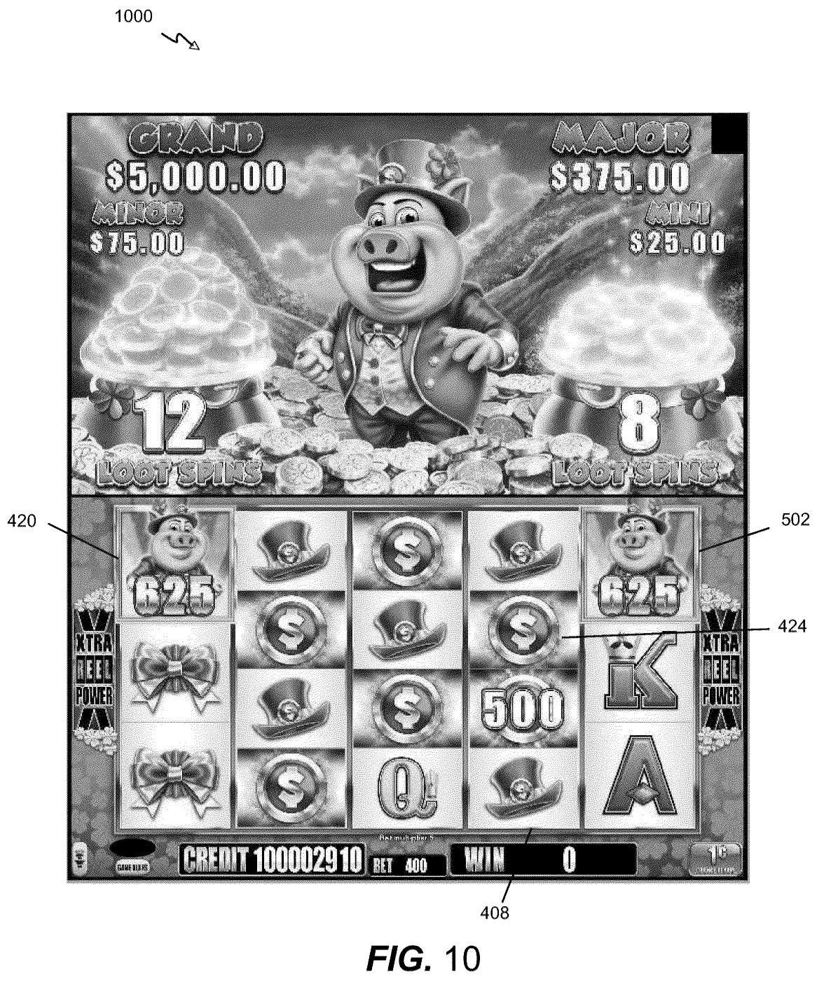

FIG. 10 illustrates another example screenshot and/or interface 1000 of the electronic game with symbol collection shown in FIG. 4A, in accordance with the present disclosure. As shown in FIG. 10, a COR symbol value (e.g., 125) associated with a first COR symbol 424 on reel 408 has been applied to qualifier symbols 420, 502. Accordingly, the first COR symbol 424 on reel 408 has changed display state (e.g., to a $ symbol) to communicate that the COR symbol value associated therewith has been applied to qualifier symbols 420, 502.

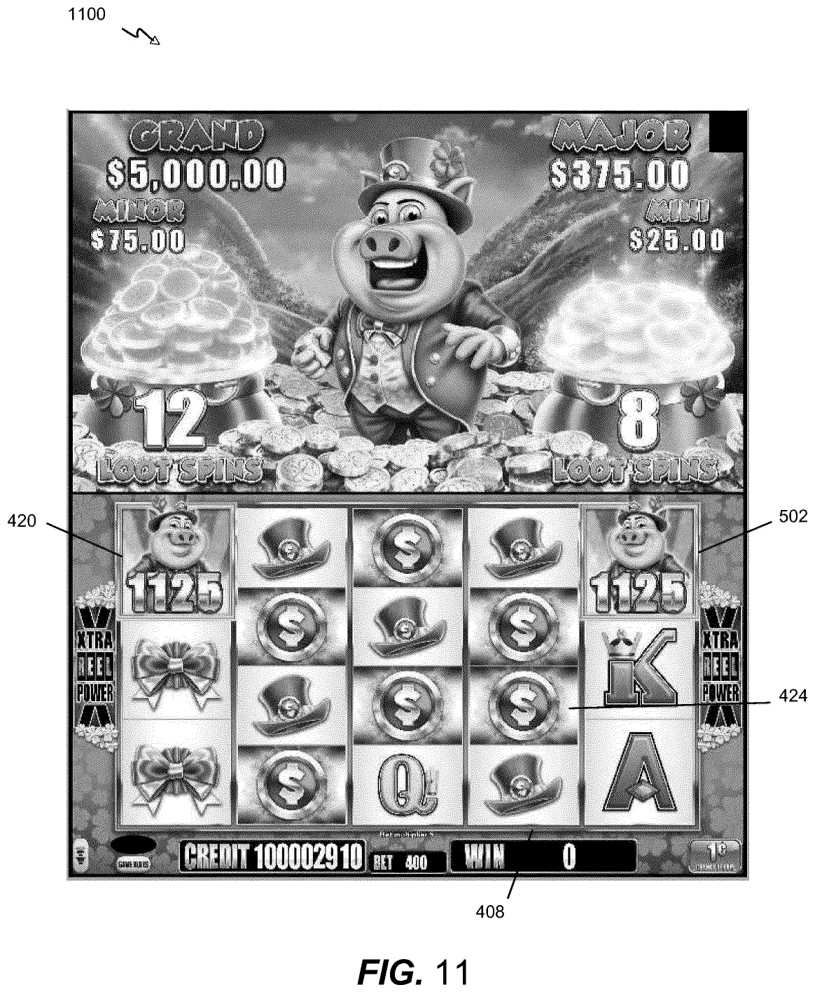

FIG. 11 illustrates another example screenshot and/or interface 1100 of the electronic game with symbol collection shown in FIG. 4A, in accordance with the present disclosure. As shown in FIG. 11, a COR symbol value (e.g., 500) associated with a second COR symbol 424 on reel 408 has been applied to qualifier symbols 420, 502. Accordingly, the second COR symbol 424 on reel 408 has changed display state (e.g., to a $ symbol) to communicate that the COR symbol value associated therewith has been applied to qualifier symbols 420, 502.

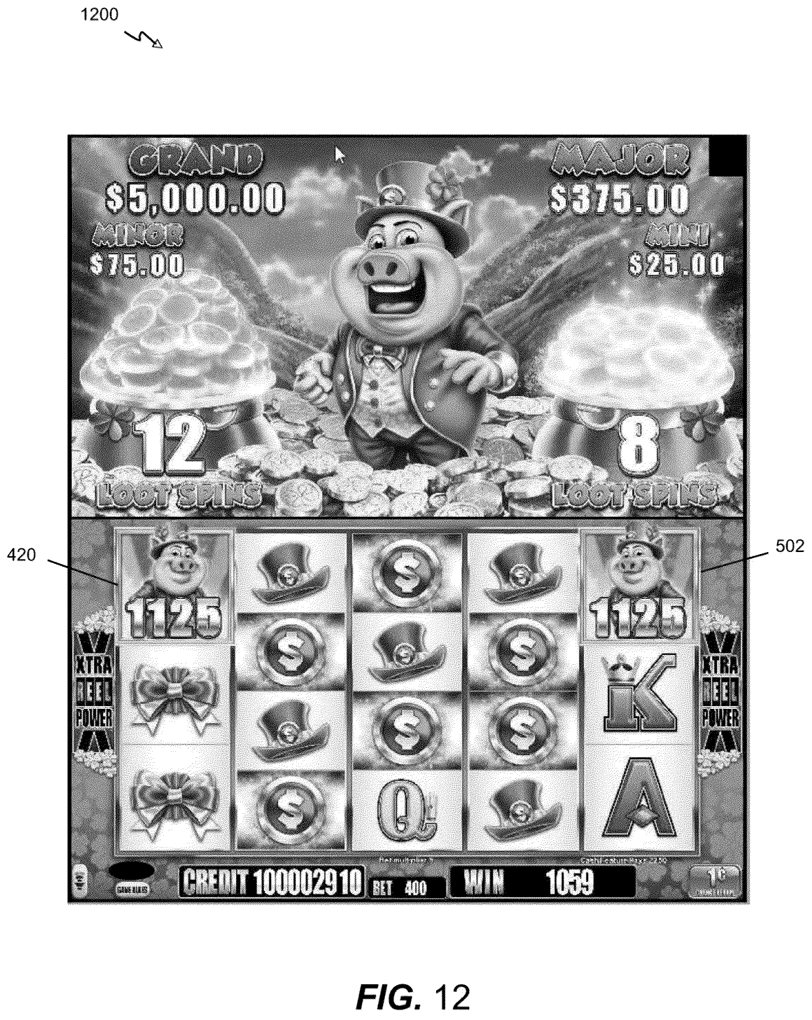

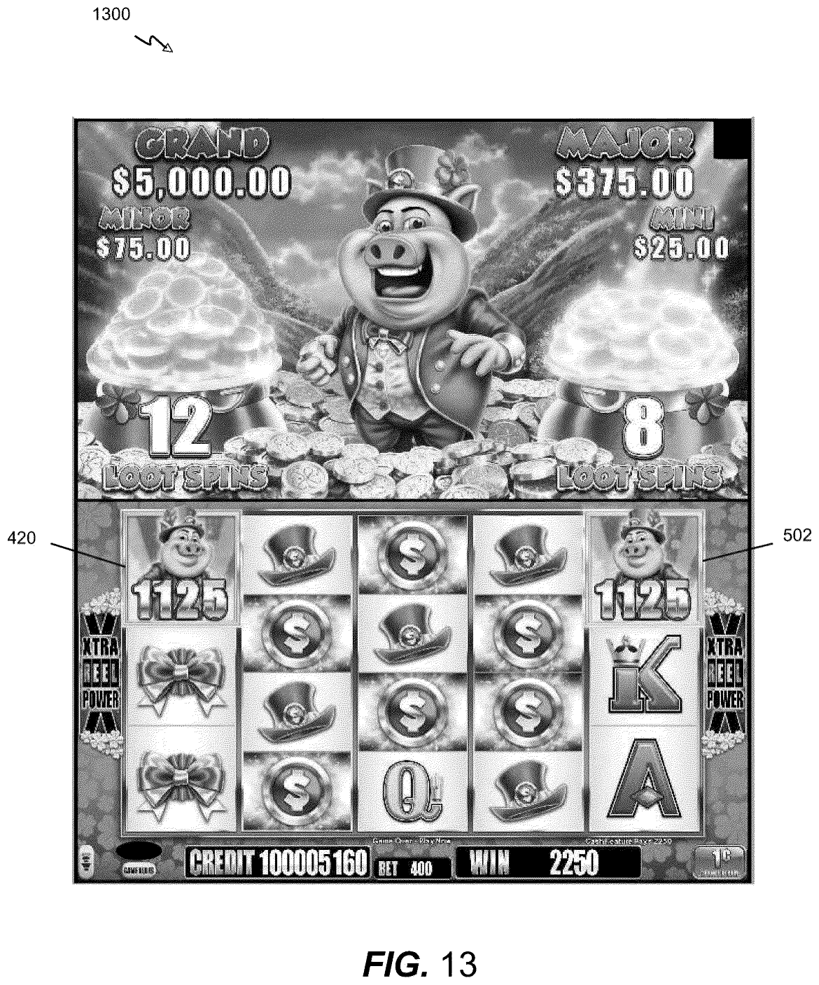

FIG. 12 illustrates another example screenshot and/or interface 1200 of the electronic game with symbol collection shown in FIG. 4A, in accordance with the present disclosure after all COR symbol values associated with COR symbols 424 displayed on reels 404-408 have been applied to qualifier symbols 420, 502. FIG. 13 illustrates another example screenshot and/or interface 1300 of the electronic game with symbol collection shown in FIG. 4A, in accordance with the present disclosure after all COR symbol values associated with COR symbols 424 displayed on reels 404-408 have been applied to qualifier symbols 420, 502.

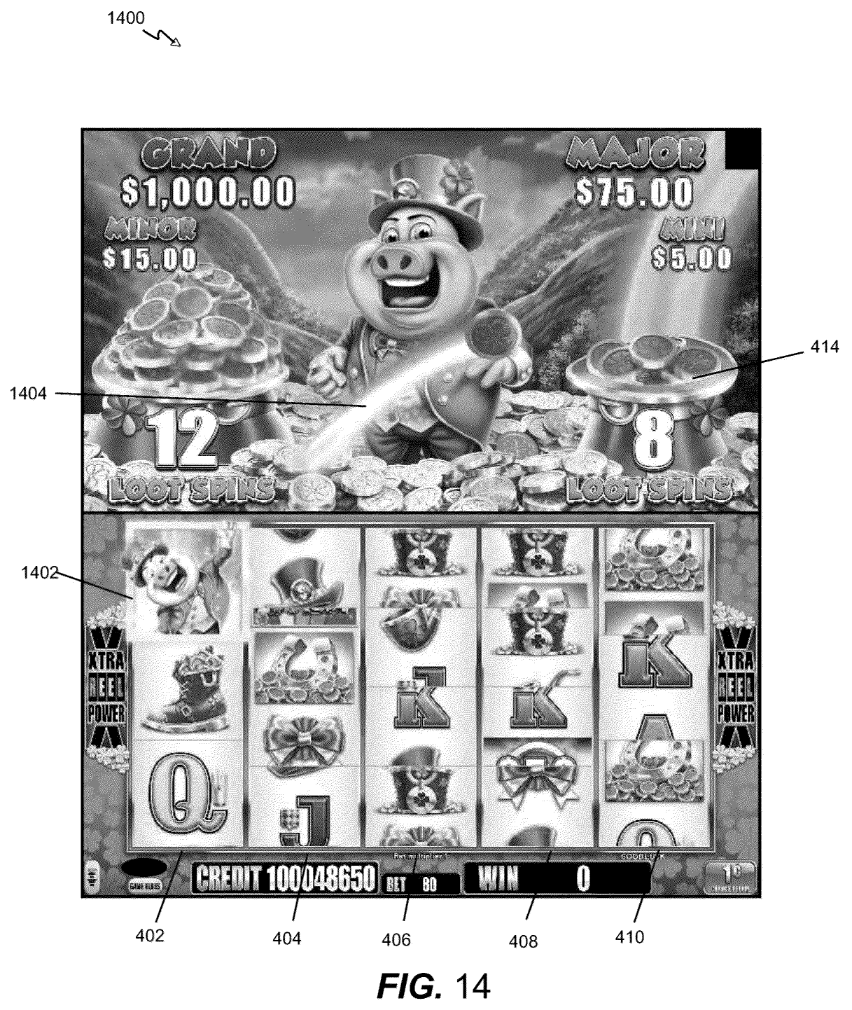

FIG. 14 illustrates an example screenshot and/or interface 1400 of an electronic game with symbol collection, in accordance with the present disclosure. For instance, FIG. 14 illustrates another example play of the base game shown in FIGS. 4A-13. As shown in FIG. 14, a qualifier symbol 1402 has landed on reel 402. Accordingly, an animation 1404 is shown between qualifier symbol 1402 and metamorphic 414. Reels 404-410 are shown as still spinning.

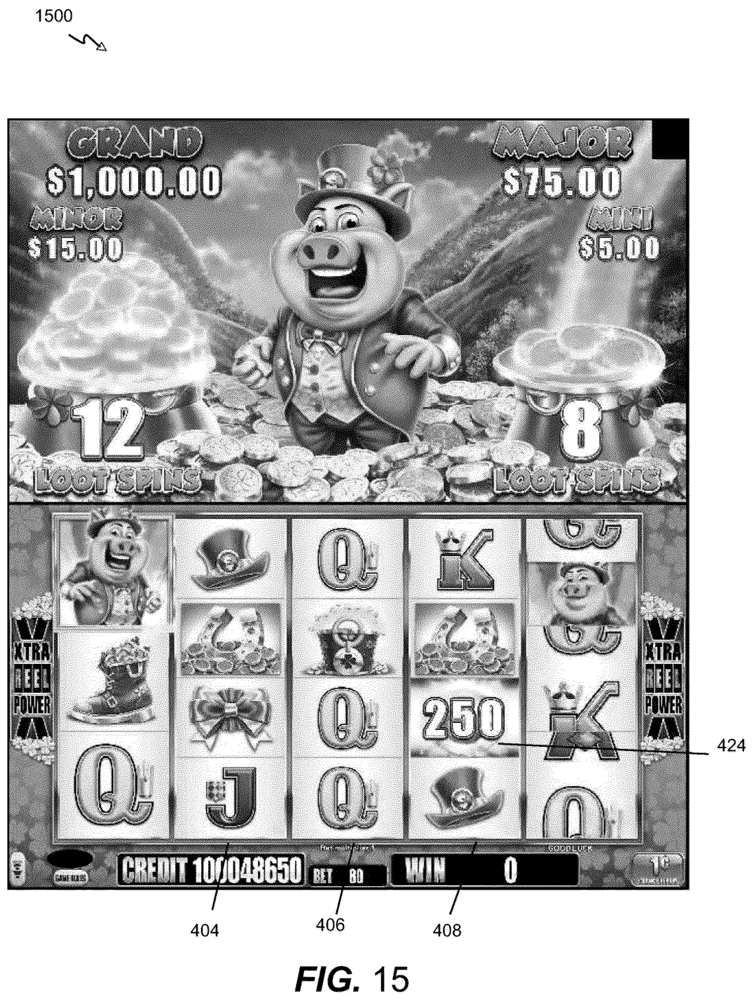

FIG. 15 illustrates another example screenshot and/or interface 1500 of the electronic game with symbol collection shown in FIG. 14, in accordance with the present disclosure after reels 404-408 have stopped spinning. Notably, a COR symbol 424 is provided on reel 408 (e.g., and will be applied to qualifier symbol 1402).

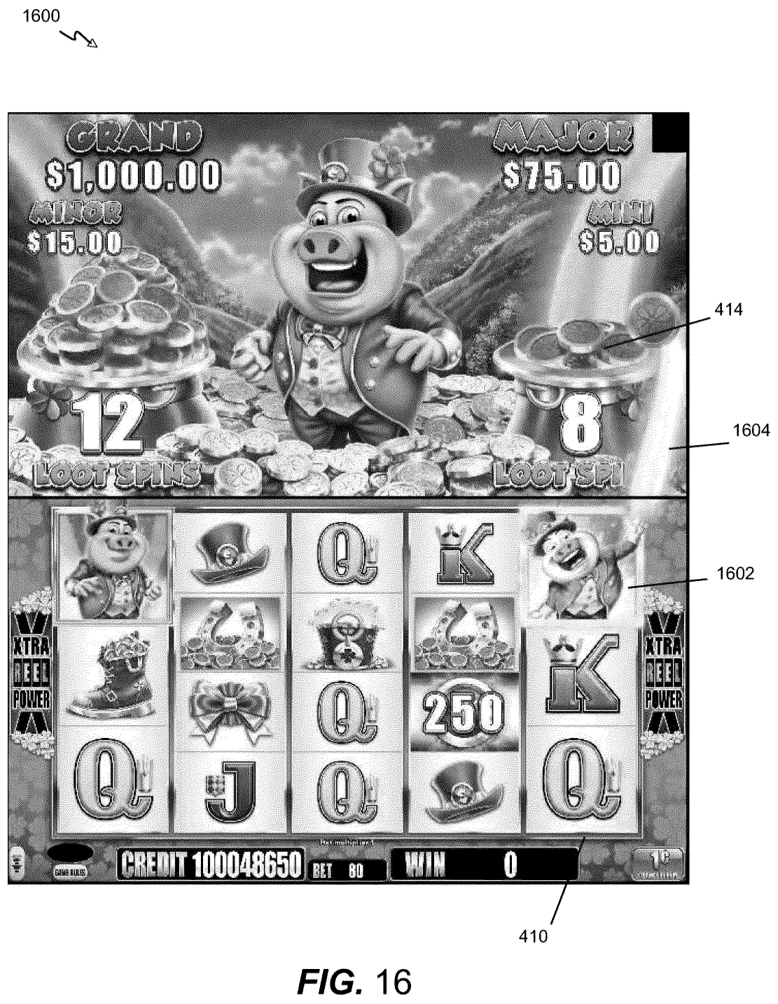

FIG. 16 illustrates another example screenshot and/or interface 1600 of the electronic game with symbol collection shown in FIG. 14, in accordance with the present disclosure after reel 410 has stopped spinning. Notably, a qualifier symbol 1602 is provided on reel 410. Accordingly, an animation 1604 is shown between qualifier symbol 1602 and metamorphic 414.

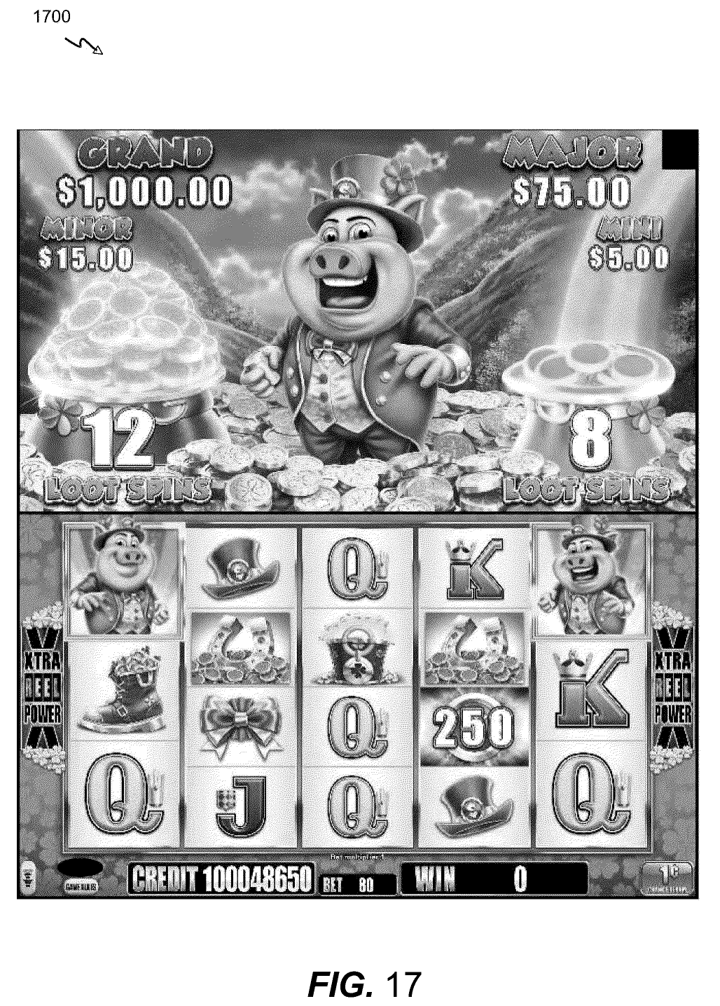

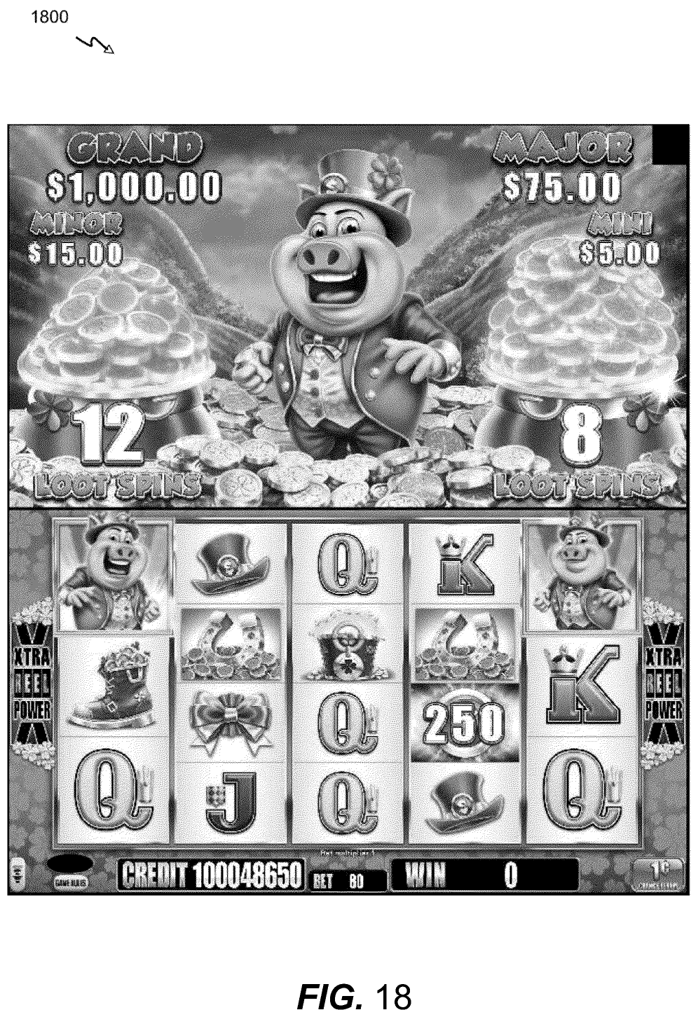

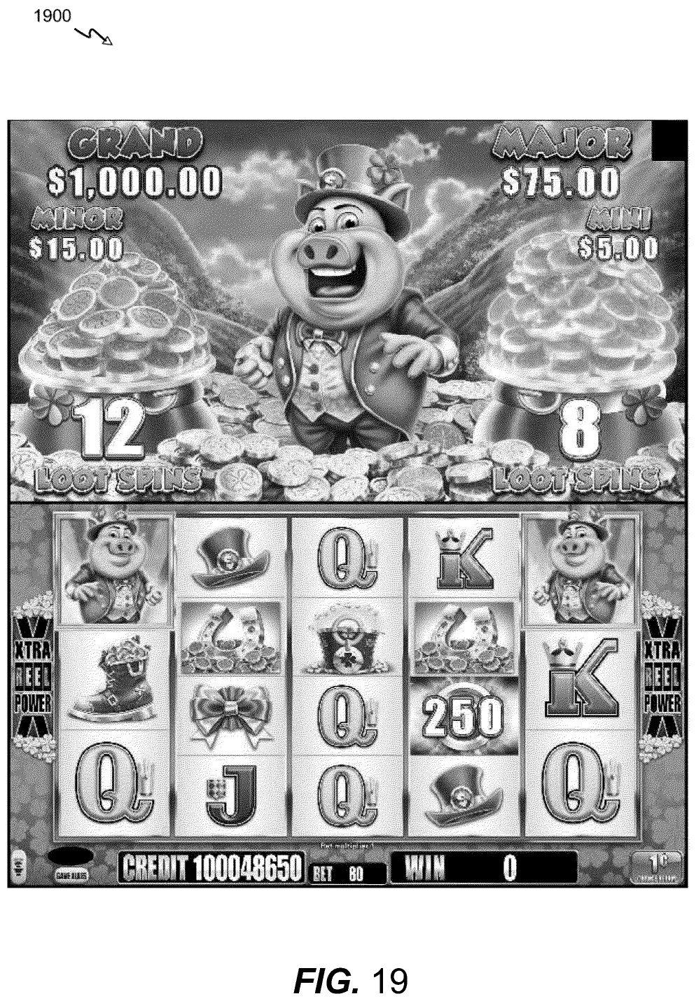

FIG. 17 illustrates another example screenshot and/or interface 1700 of the electronic game with symbol collection shown in FIG. 14, in accordance with the present disclosure after reels 402-410 have stopped spinning. FIG. 18 illustrates another example screenshot and/or interface 1800 of the electronic game with symbol collection shown in FIG. 14, in accordance with the present disclosure after reels 402-410 have stopped spinning. FIG. 19 illustrates another example screenshot and/or interface 1900 of the electronic game with symbol collection shown in FIG. 14, in accordance with the present disclosure after reels 402-410 have stopped spinning.

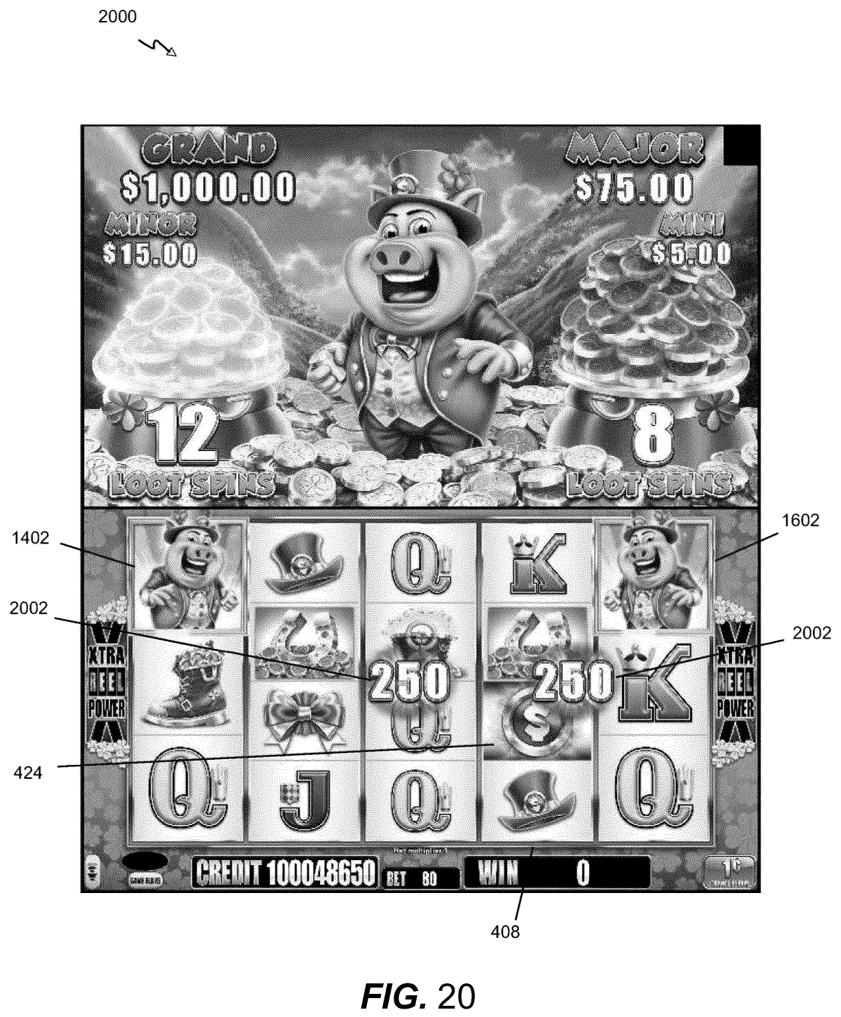

FIG. 20 illustrates another example screenshot and/or interface 2000 of the electronic game with symbol collection shown in FIG. 14, in accordance with the present disclosure after reels 402-410 have stopped spinning. In the example embodiment, COR symbol values may be displayed as being animated between the COR symbol they are associated with and any displayed qualifier symbols to communicate that the COR symbol values are being applied to the displayed qualifier symbols.

Accordingly, as shown in FIG. 20, COR symbol values 2002 are displayed as being animated between COR symbol 424 on reel 408 and qualifier symbols 1402, 1602. Further, COR symbol 424 on reel 408 has changed display state (e.g., from displaying the COR symbol value 2002 to displaying a $ symbol) to communicate that COR symbol values 2002 are being applied to (e.g., and/or have already been applied to) qualifier symbols 1402, 1602.

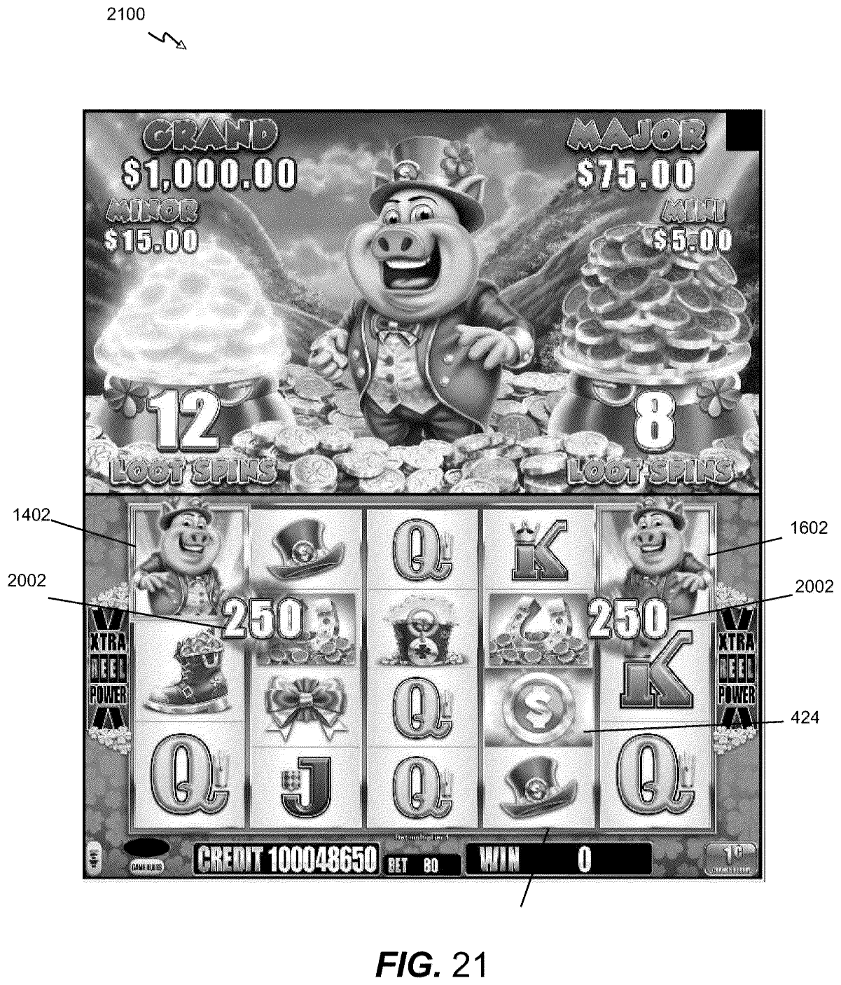

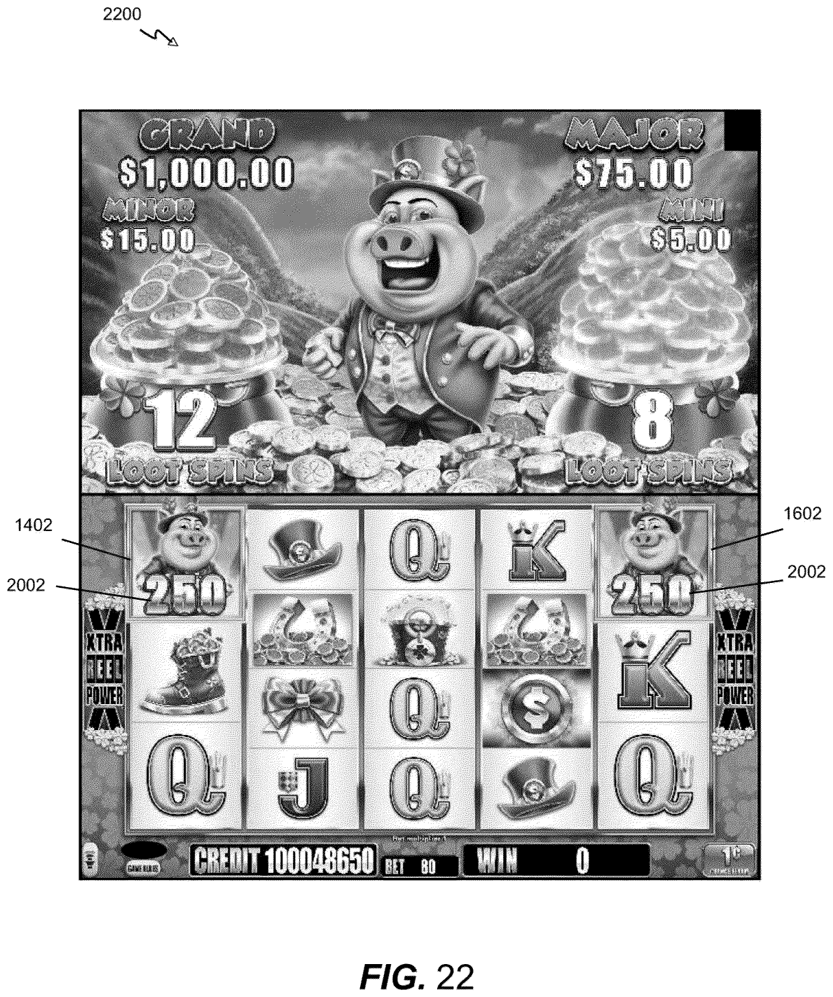

FIG. 21 illustrates another example screenshot and/or interface 2100 of the electronic game with symbol collection shown in FIG. 14, in accordance with the present disclosure as COR symbol values 2002 are displayed as being animated between COR symbol 424 on reel 408 and qualifier symbols 1402, 1602. FIG. 22 illustrates another example screenshot and/or interface 2200 of the electronic game with symbol collection shown in FIG. 14, in accordance with the present disclosure after COR symbol values 2002 have landed on and/or been applied to qualifier symbols 1402, 1602.

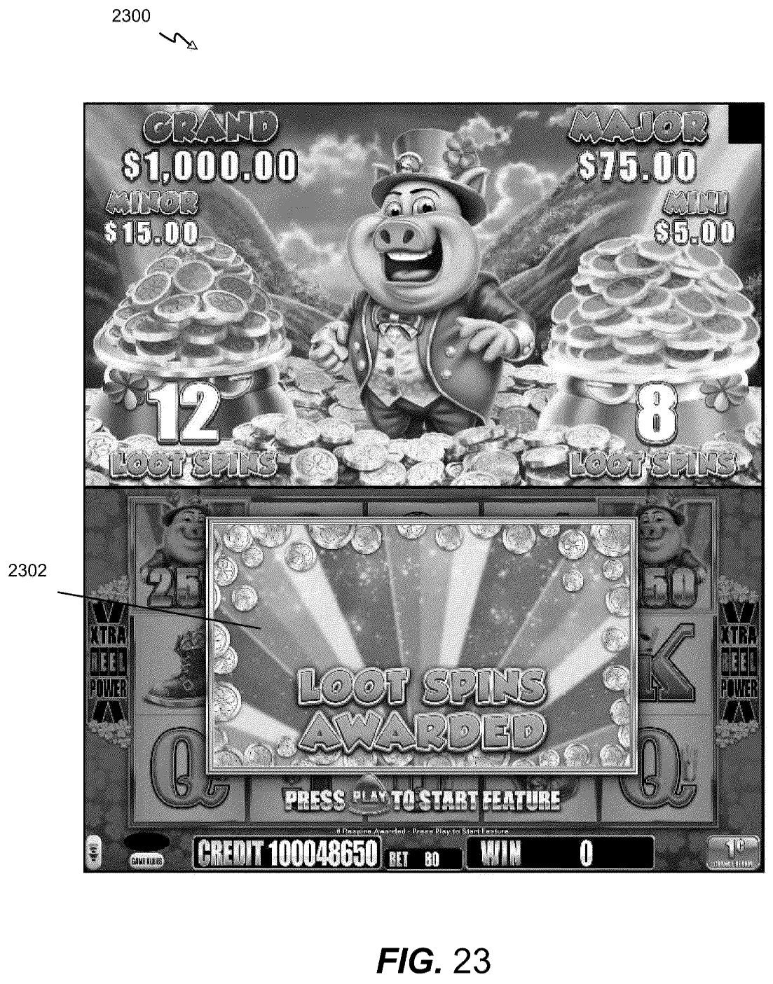

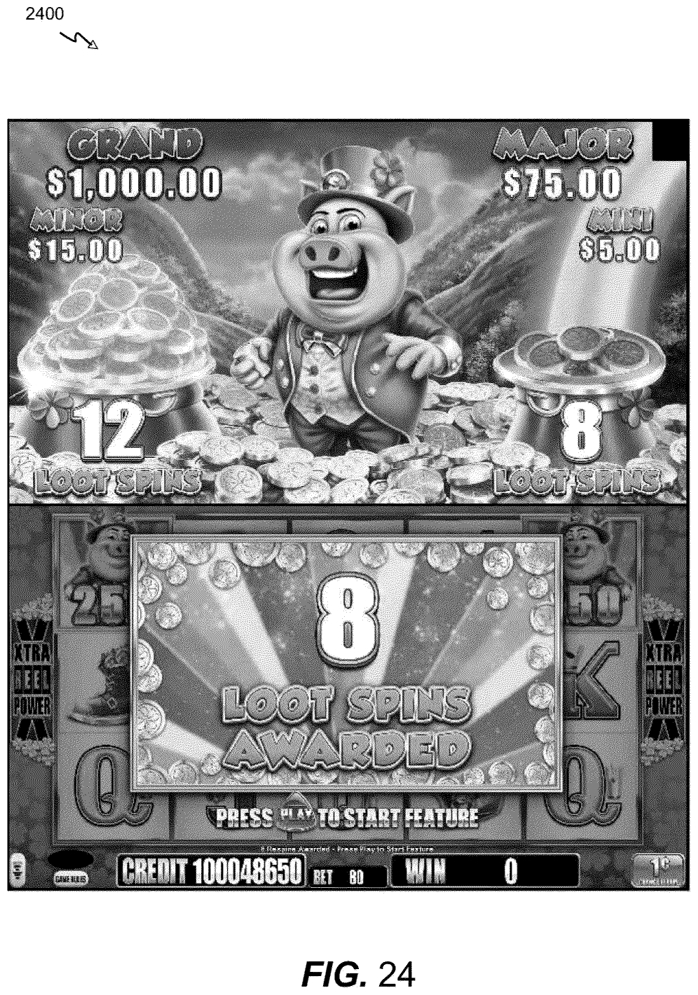

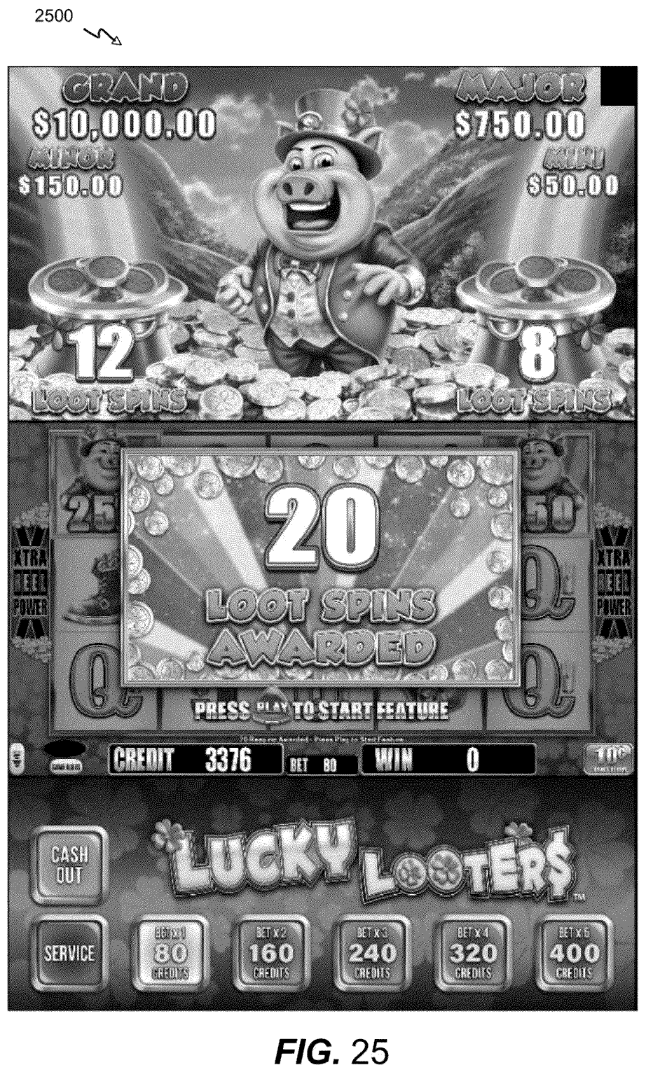

FIG. 23 illustrates an example screenshot and/or interface 2300 of a transition from the electronic game shown in FIG. 14 to another electronic game with symbol collection, in accordance with the present disclosure. As shown in FIG. 23, the feature game has been triggered. Accordingly, a message 2302 is displayed to communicate that a number of spins (e.g., loot spins, or free spins) have been provided for the feature game. FIG. 24 illustrates an example screenshot and/or interface 2400 of a transition from the electronic game shown in FIG. 14 where eight loot spins are provided for the feature game while FIG. 25 illustrates an example screenshot and/or interface 2500 of a transition from the electronic game shown in FIG. 14 where twenty loot spins are provided for the feature game.

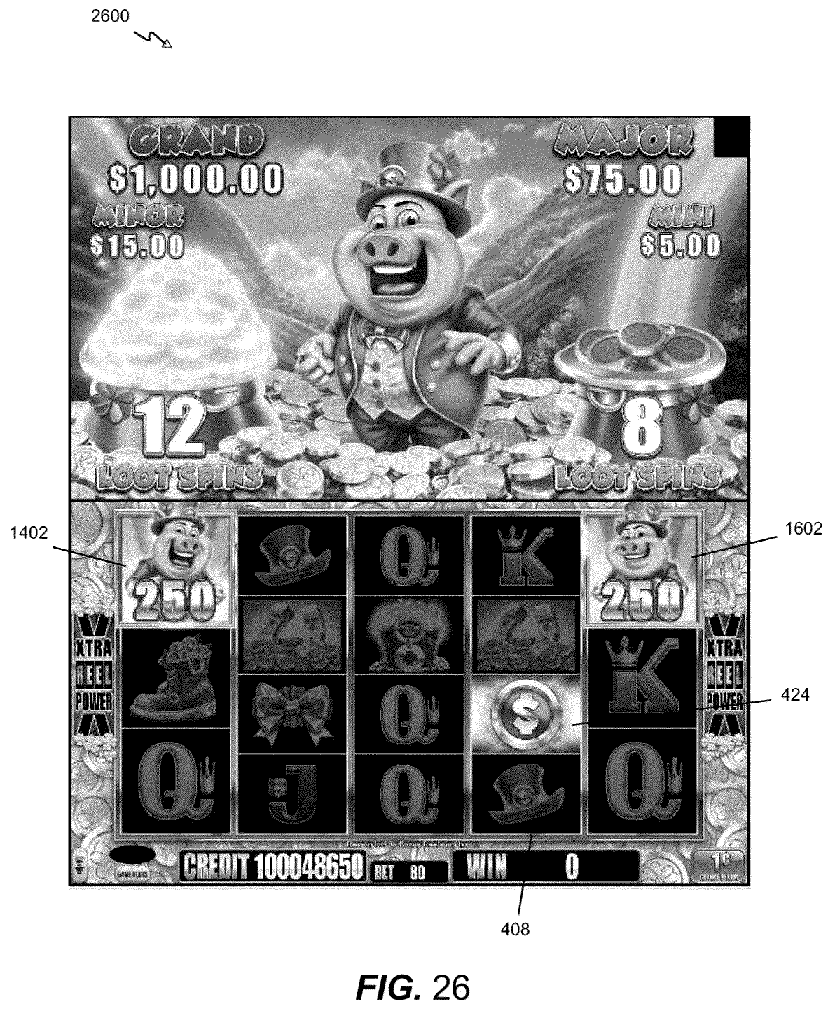

FIG. 26 illustrates another example screenshot and/or interface 2600 of an electronic game with symbol collection, in accordance with the present disclosure. For instance, FIG. 26 shows an example of the feature game described herein.

Notably, the values associated with qualifier symbols 1402, 1602 (e.g., 250) have been carried through from the base game to the feature game. Further, to efficiently communicate which symbols that may be provided in the feature game (e.g., qualifier symbols and/or COR symbols), symbols that are eligible to be provided in the feature game are shown as being illuminated. Additionally, to efficiently communicate which symbols may not be provided in the feature game (e.g., any symbols that are not qualifier symbols and/or COR symbols), symbols that are ineligible to be provided in the feature game are shown as being greyed out (e.g., dull). Accordingly, as shown in FIG. 26, qualifier symbols 1402, 1602 and COR symbol 424 on reel 408 (e.g., in the second, $, display state) are displayed as being illuminated while the remaining displayed symbols are displayed as being dull.

In the example embodiment, while reels 402-410 are spinning, symbols that are eligible to be provided are displayed as being illuminated while symbols that are ineligible to be provided are greyed out, as explained above.

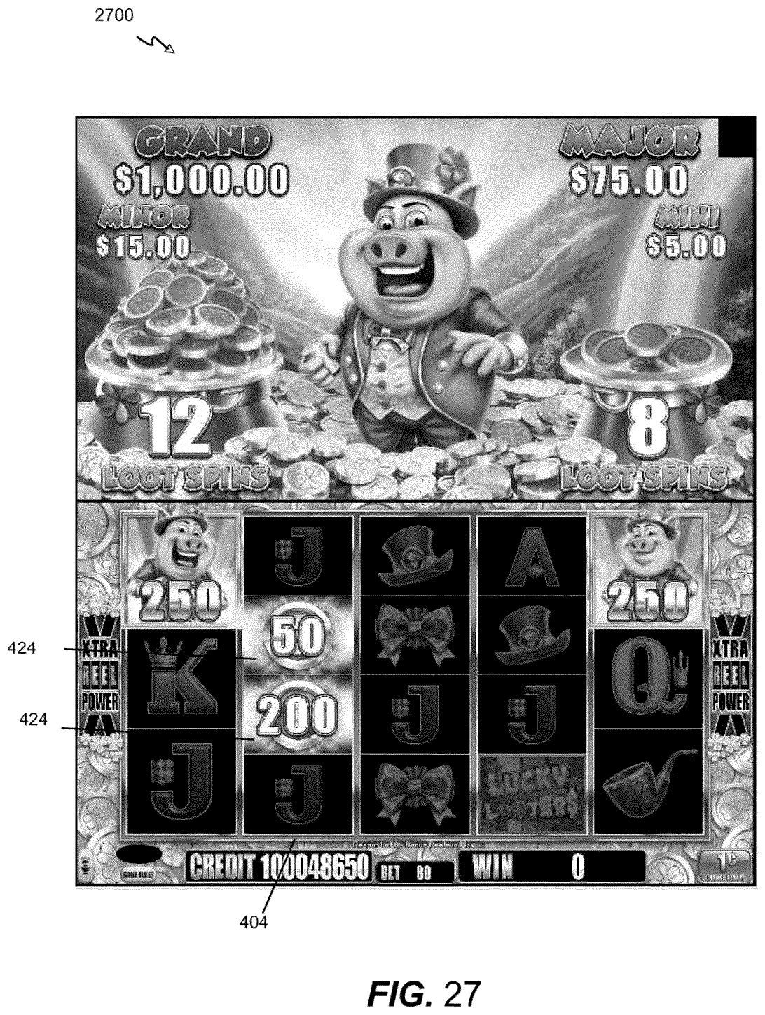

FIG. 27 illustrates another example screenshot and/or interface 2700 of the electronic game with symbol collection shown in FIG. 26, in accordance with the present disclosure. For instance, FIG. 27 shows the outcome of a first spin of the feature game.

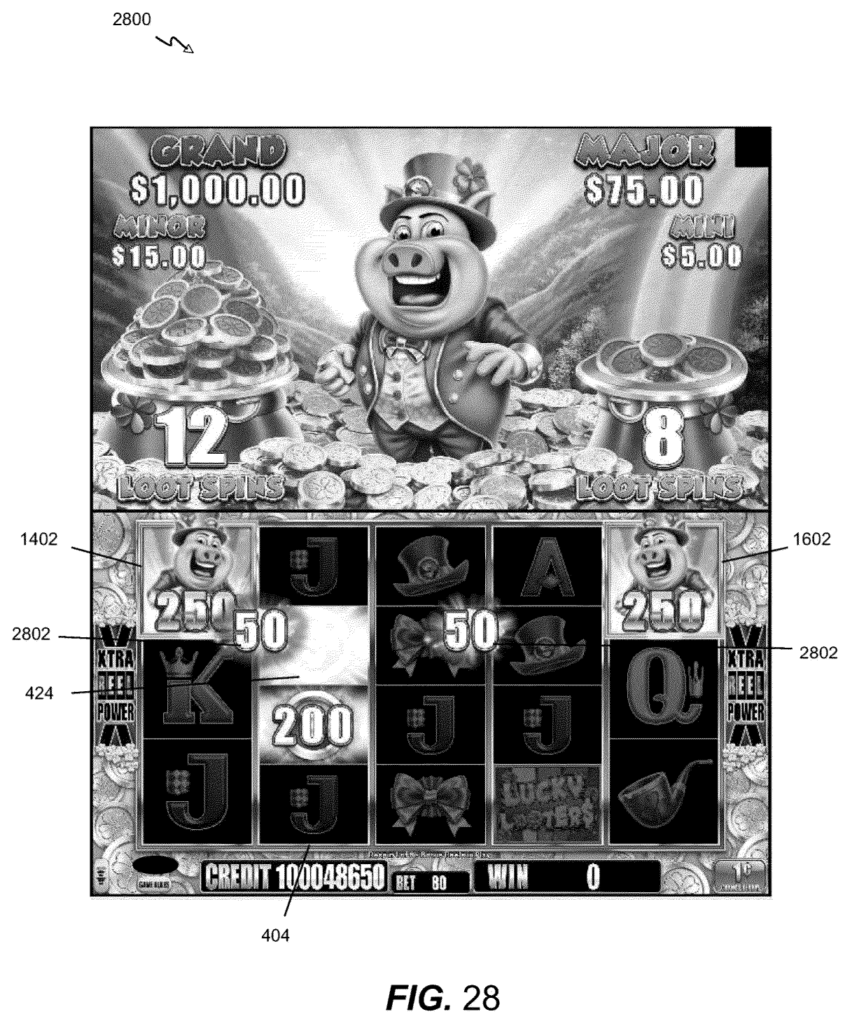

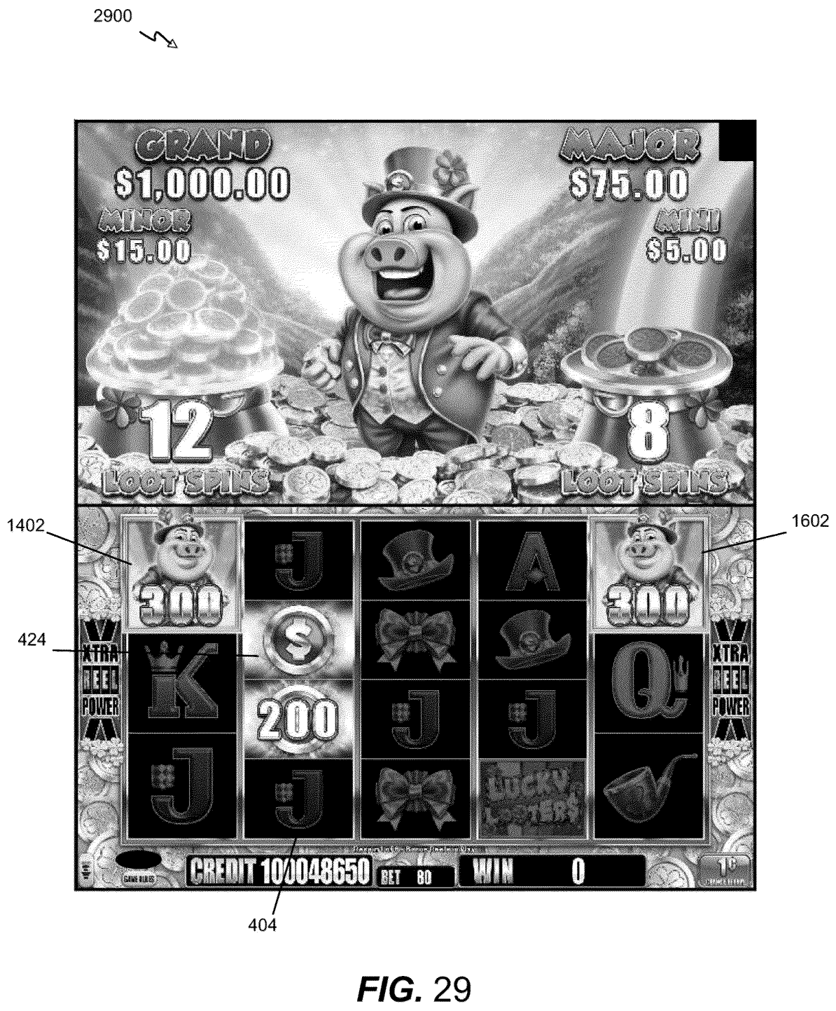

As shown in FIG. 27, two COR symbols 424 are displayed on reel 404. FIG. 28 illustrates another example screenshot and/or interface 2800 of the electronic game with symbol collection shown in FIG. 26, in accordance with the present disclosure where COR symbol values 2802 associated with the first COR symbol 424 on reel 404 are shown as being animated between the first COR symbol 424 on reel 404 and qualifier symbols 1402, 1602 to illustrate that COR symbol values 2802 will be applied to qualifier symbols 1402, 1602. FIG. 29 illustrates another example screenshot and/or interface 2900 of the electronic game with symbol collection shown in FIG. 26, in accordance with the present disclosure where COR symbol values 2802 have been applied to qualifier symbols 1402, 1602 and the first COR symbol 424 on reel 404 has changed to the second display state to indicate that COR symbol values 2802 have been applied to qualifier symbols 1402, 1602.

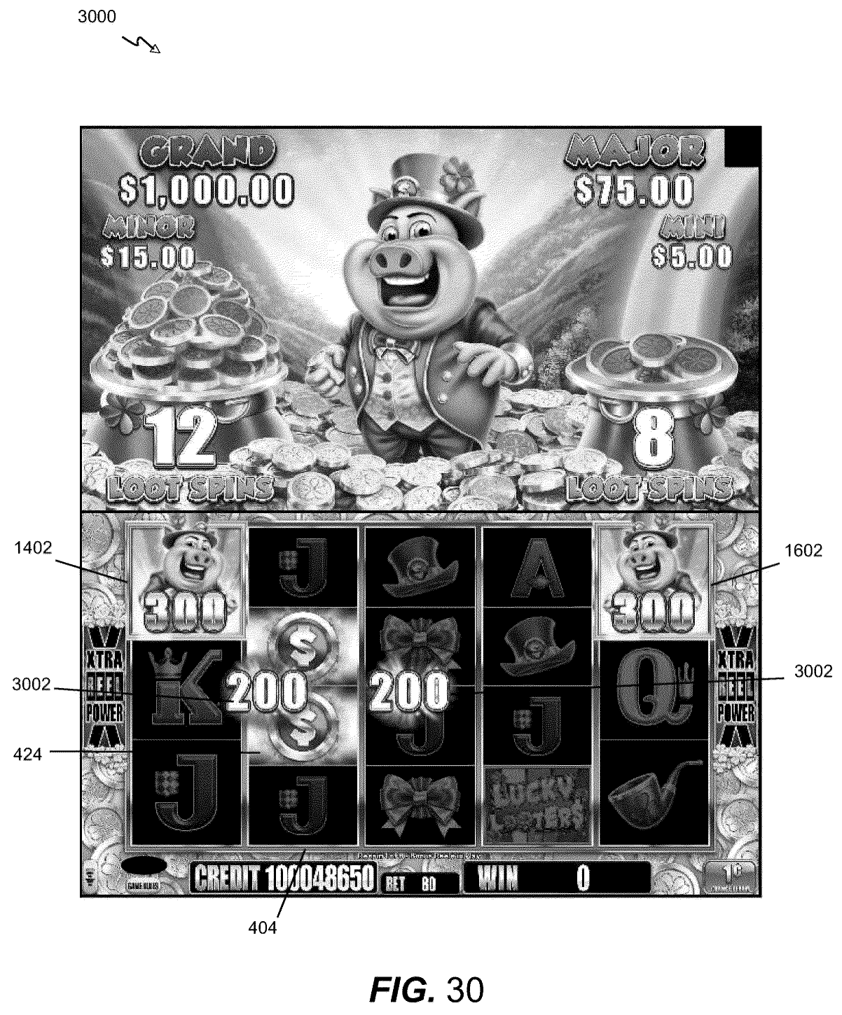

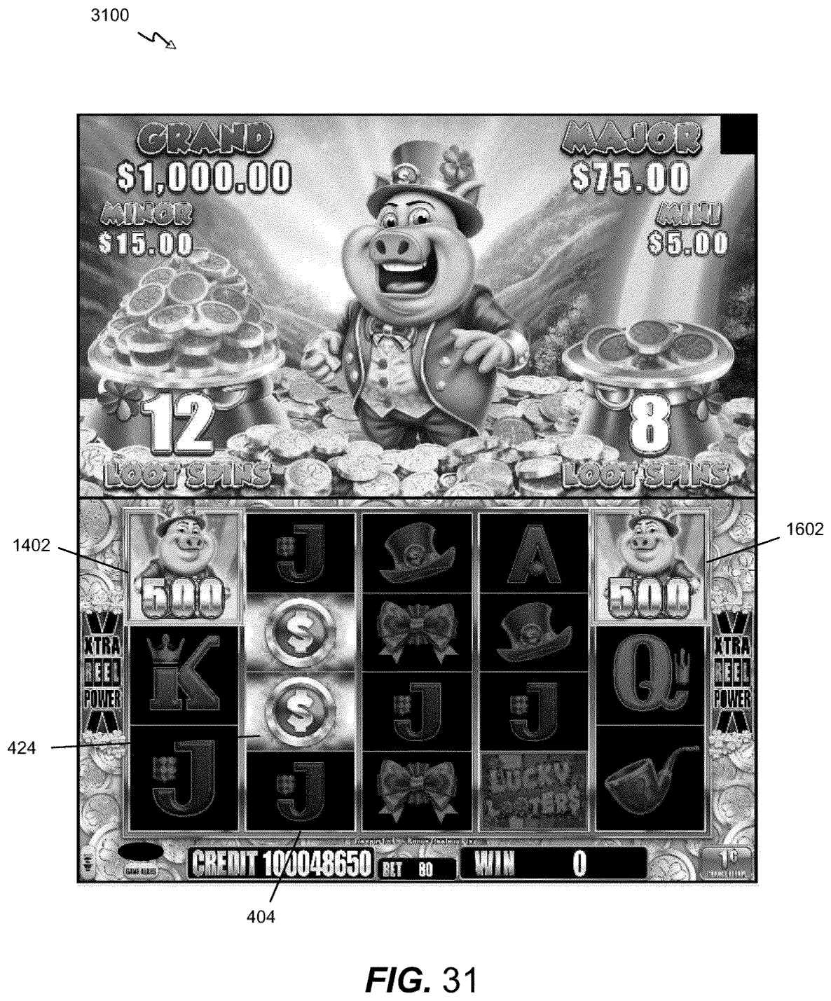

FIG. 30 illustrates another example screenshot and/or interface 3000 of the electronic game with symbol collection shown in FIG. 26, in accordance with the present disclosure where COR symbol values 3002 associated with the second COR symbol 424 on reel 404 are shown as being animated between the second COR symbol 424 on reel 404 and qualifier symbols 1402, 1602 to illustrate that COR symbol values 3002 will be applied to qualifier symbols 1402, 1602. FIG. 31 illustrates another example screenshot and/or interface 3100 of the electronic game with symbol collection shown in FIG. 26, in accordance with the present disclosure where COR symbol values 3002 have been applied to qualifier symbols 1402, 1602 and the second COR symbol 424 on reel 404 has changed to the second display state to indicate that COR symbol values 3002 have been applied to qualifier symbols 1402, 1602.

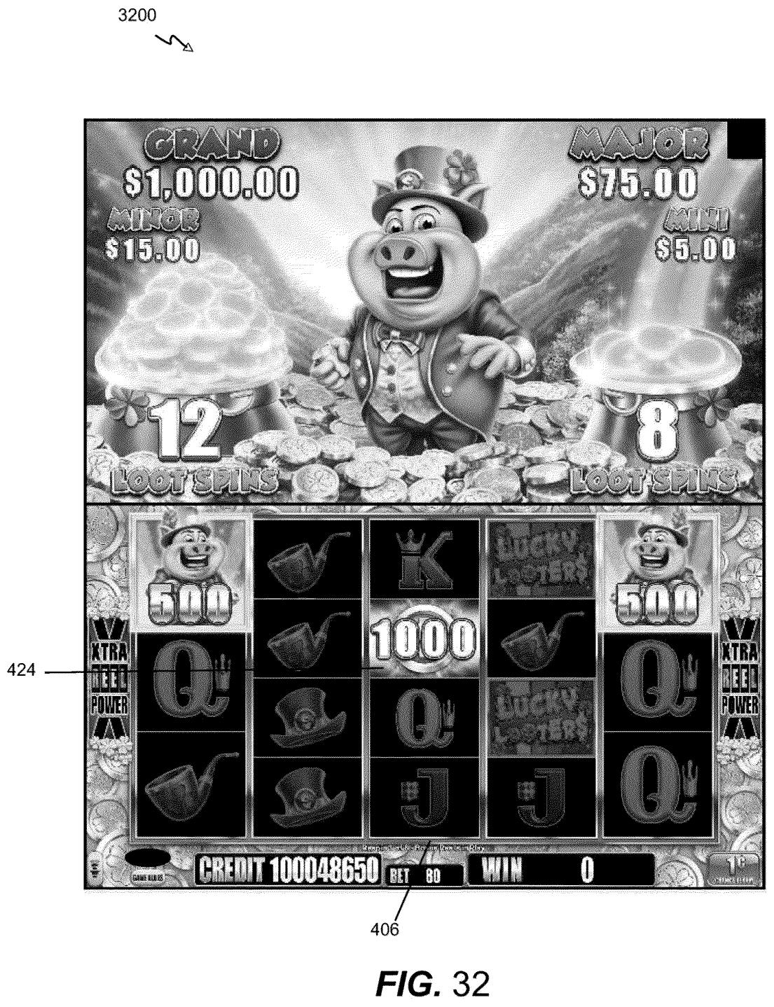

FIG. 32 illustrates another example screenshot and/or interface 3200 of the electronic game with symbol collection shown in FIG. 26, in accordance with the present disclosure. For instance, FIG. 32 shows the outcome of a second spin of the feature game.

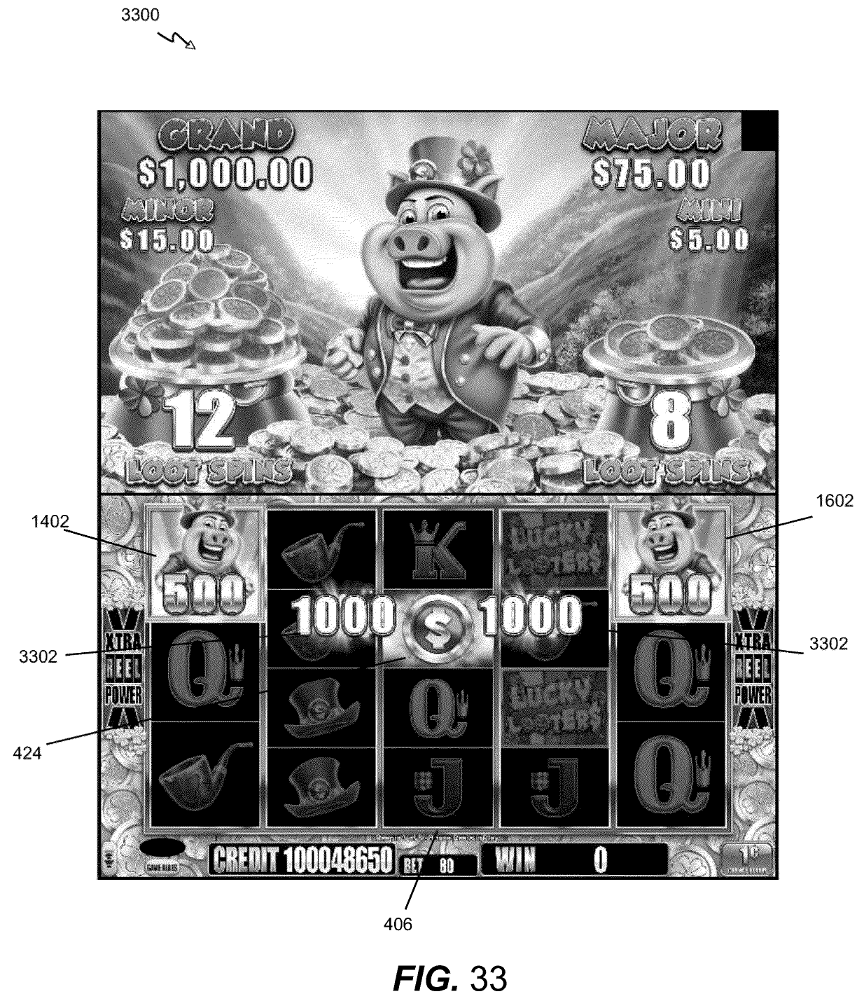

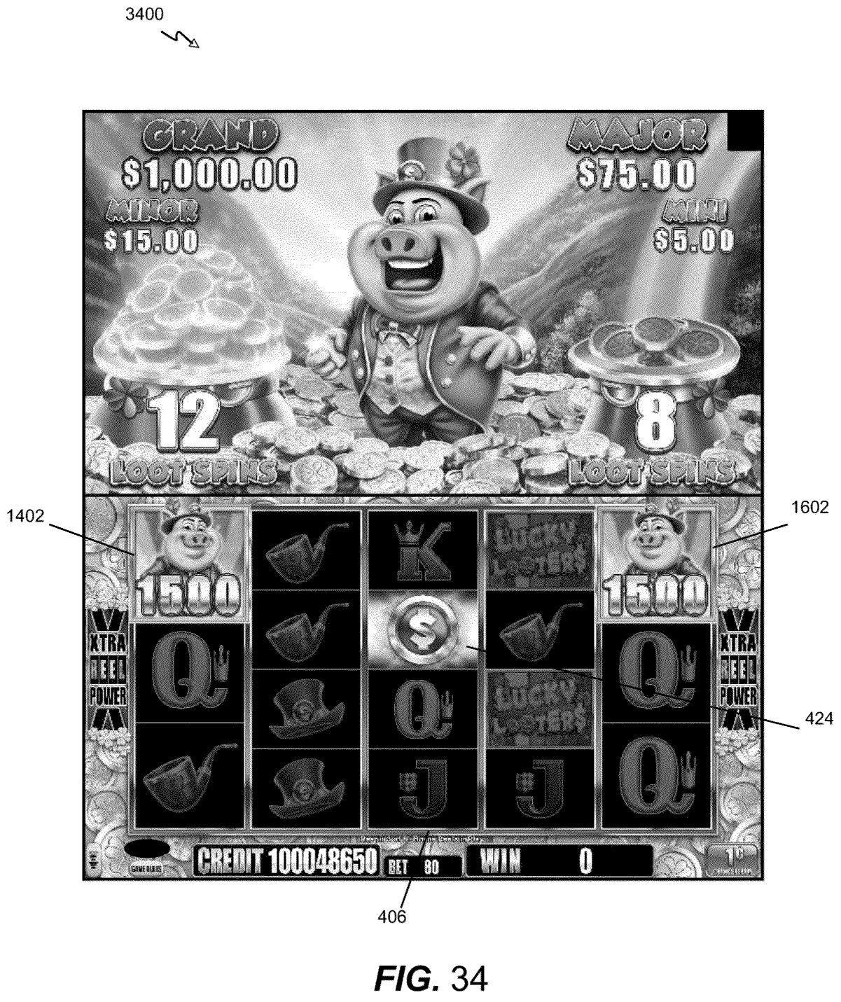

As shown in FIG. 32, a COR symbol 424 is displayed on reel 406. FIG. 33 illustrates another example screenshot and/or interface 3300 of the electronic game with symbol collection shown in FIG. 26, in accordance with the present disclosure where COR symbol values 3302 associated with the COR symbol 424 on reel 406 are shown as being animated between the COR symbol 424 on reel 406 and qualifier symbols 1402, 1602 to illustrate that COR symbol values 3302 will be applied to qualifier symbols 1402, 1602. FIG. 34 illustrates another example screenshot and/or interface 3400 of the electronic game with symbol collection shown in FIG. 26, in accordance with the present disclosure where COR symbol values 3302 have been applied to qualifier symbols 1402, 1602 and the COR symbol 424 on reel 406 has changed to the second display state to indicate that COR symbol values 3302 have been applied to qualifier symbols 1402, 1602.

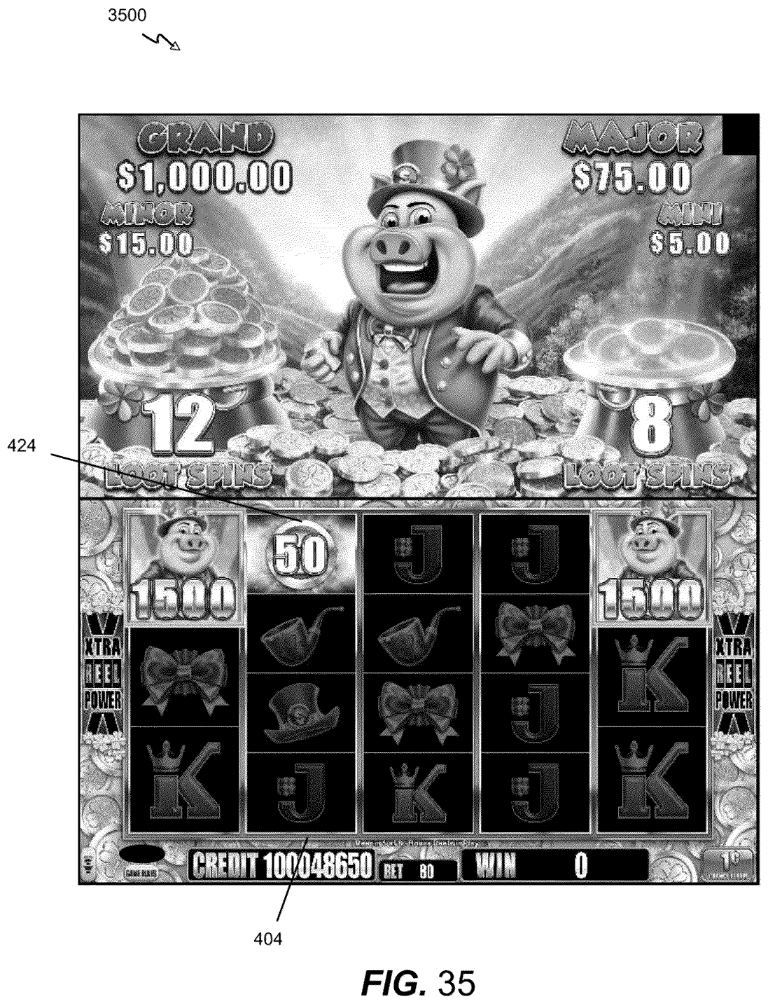

FIG. 35 illustrates another example screenshot and/or interface 3500 of the electronic game with symbol collection shown in FIG. 26, in accordance with the present disclosure. For instance, FIG. 35 shows the outcome of a third spin of the feature game.

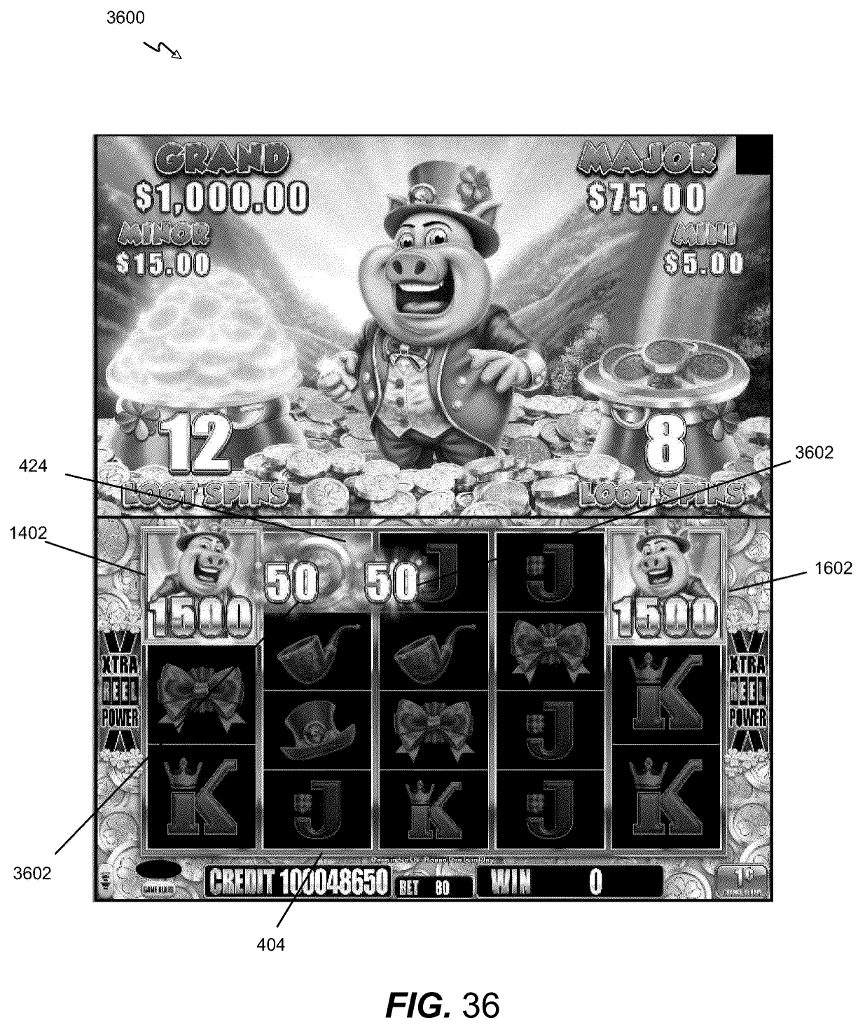

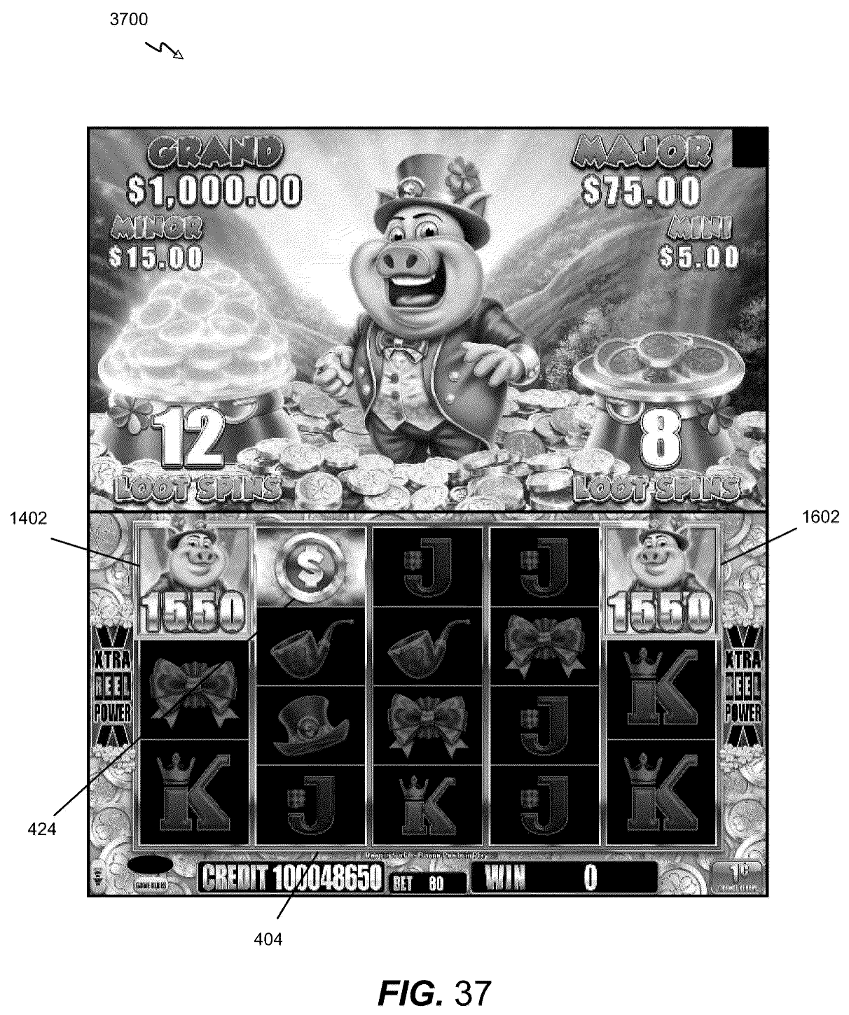

As shown in FIG. 35, a COR symbol 424 is displayed on reel 404. FIG. 36 illustrates another example screenshot and/or interface 3600 of the electronic game with symbol collection shown in FIG. 26, in accordance with the present disclosure where COR symbol values 3602 associated with the COR symbol 424 on reel 404 are shown as being animated between the COR symbol 424 on reel 404 and qualifier symbols 1402, 1602 to illustrate that COR symbol values 3602 will be applied to qualifier symbols 1402, 1602. FIG. 37 illustrates another example screenshot and/or interface 3700 of the electronic game with symbol collection shown in FIG. 26, in accordance with the present disclosure where COR symbol values 3602 have been applied to qualifier symbols 1402, 1602 and the COR symbol 424 on reel 404 has changed to the second display state to indicate that COR symbol values 3602 have been applied to qualifier symbols 1402, 1602.

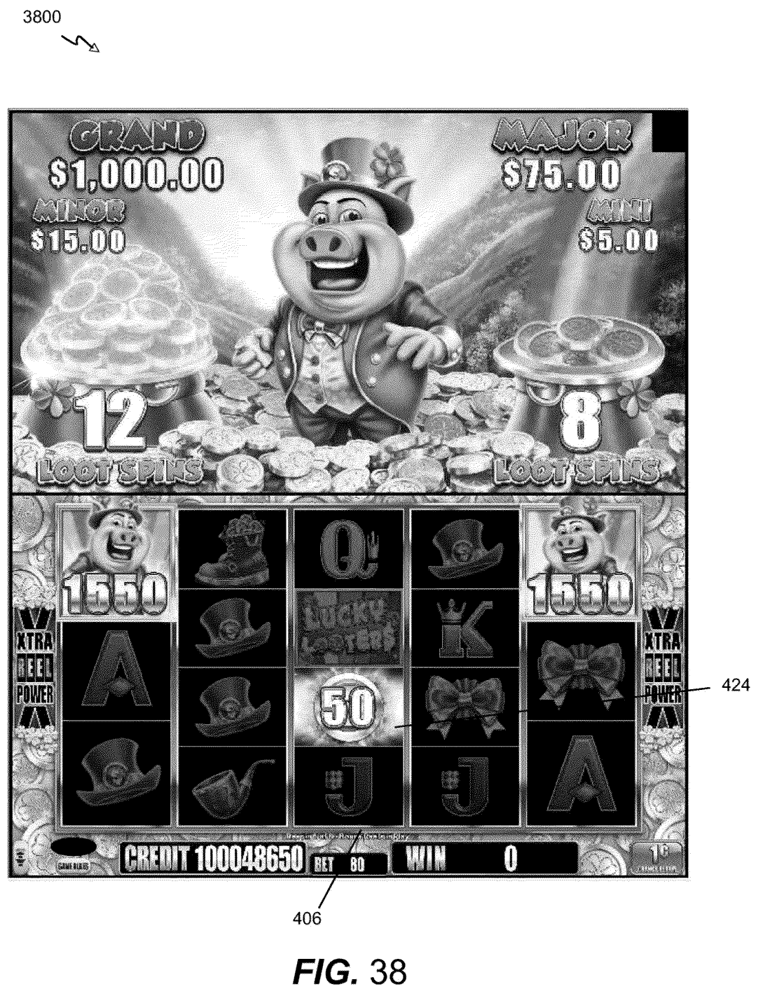

FIG. 38 illustrates another example screenshot and/or interface 3800 of the electronic game with symbol collection shown in FIG. 26, in accordance with the present disclosure. For instance, FIG. 38 shows the outcome of a fourth spin of the feature game.

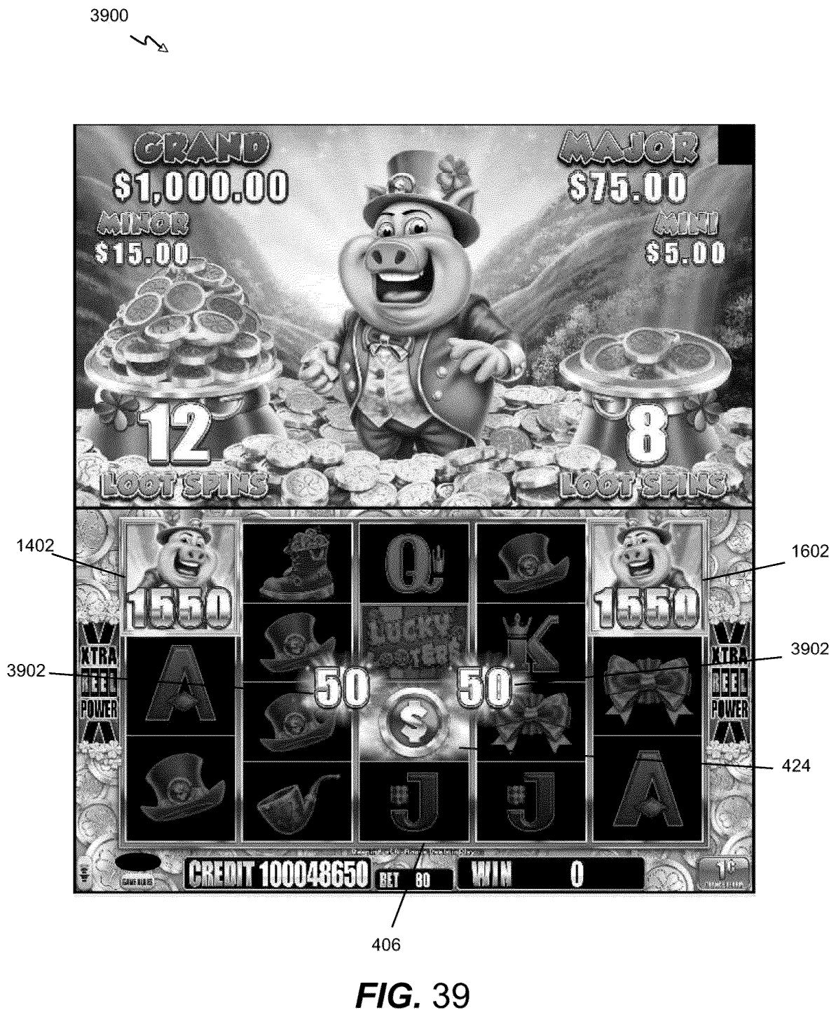

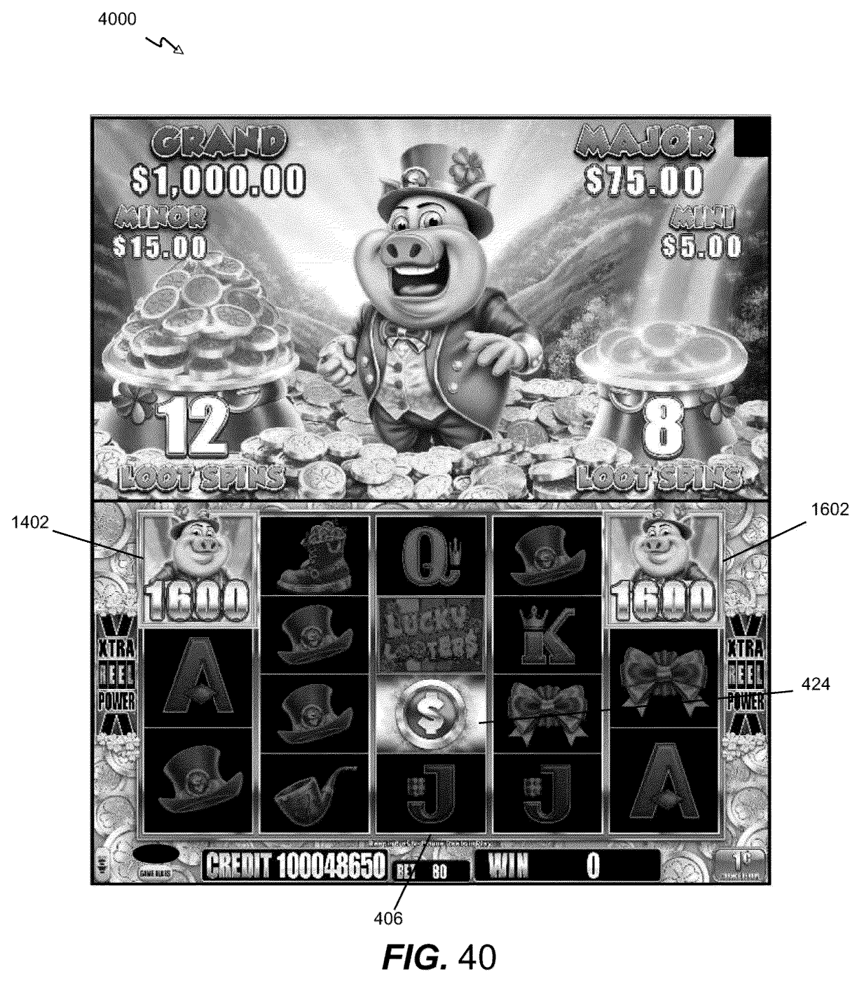

As shown in FIG. 38, a COR symbol 424 is displayed on reel 406. FIG. 39 illustrates another example screenshot and/or interface 3900 of the electronic game with symbol collection shown in FIG. 26, in accordance with the present disclosure where COR symbol values 3902 associated with the COR symbol 424 on reel 406 are shown as being animated between the COR symbol 424 on reel 406 and qualifier symbols 1402, 1602 to illustrate that COR symbol values 3902 will be applied to qualifier symbols 1402, 1602. FIG. 40 illustrates another example screenshot and/or interface 4000 of the electronic game with symbol collection shown in FIG. 26, in accordance with the present disclosure where COR symbol values 3902 have been applied to qualifier symbols 1402, 1602 and the COR symbol 424 on reel 406 has changed to the second display state to indicate that COR symbol values 3902 have been applied to qualifier symbols 1402, 1602.

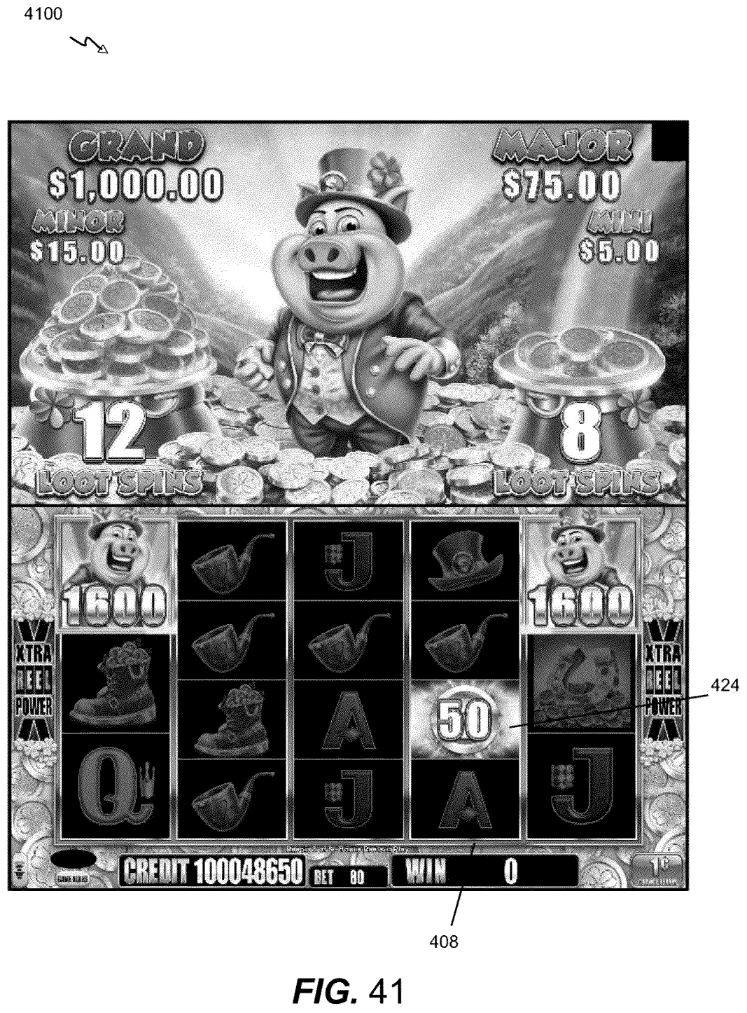

FIG. 41 illustrates another example screenshot and/or interface 4100 of the electronic game with symbol collection shown in FIG. 26, in accordance with the present disclosure. For instance, FIG. 32 shows the outcome of a fifth spin of the feature game.

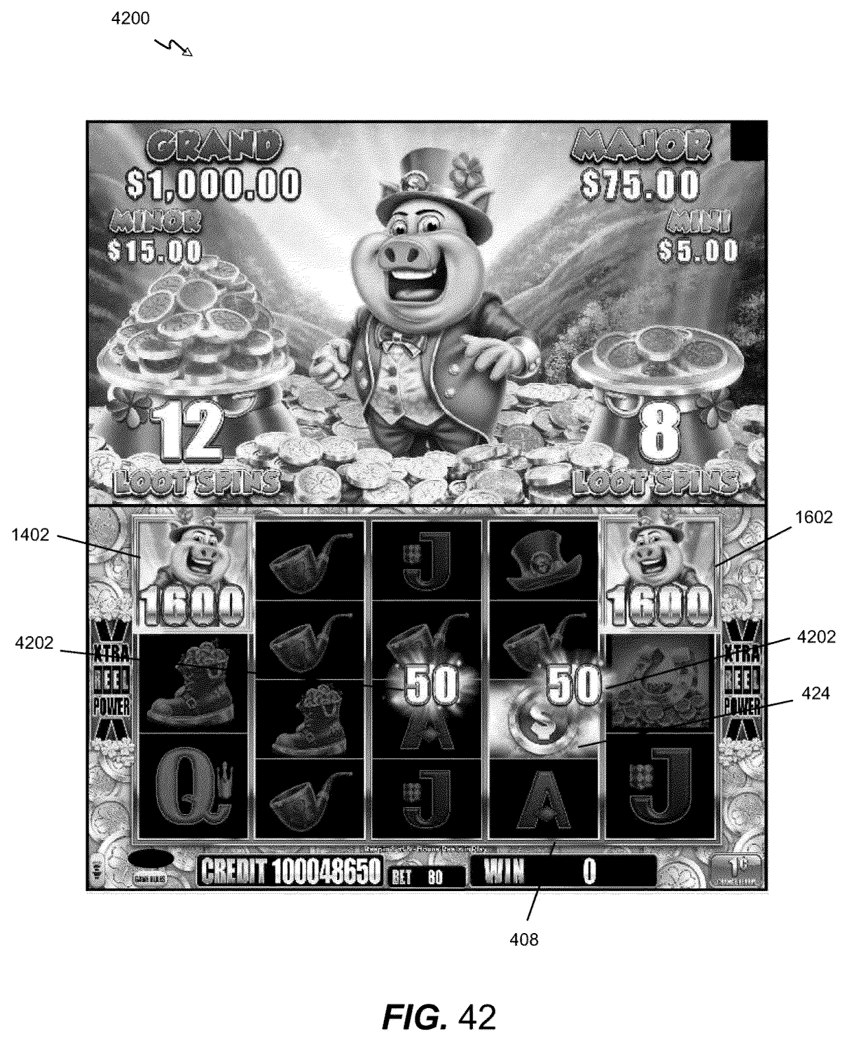

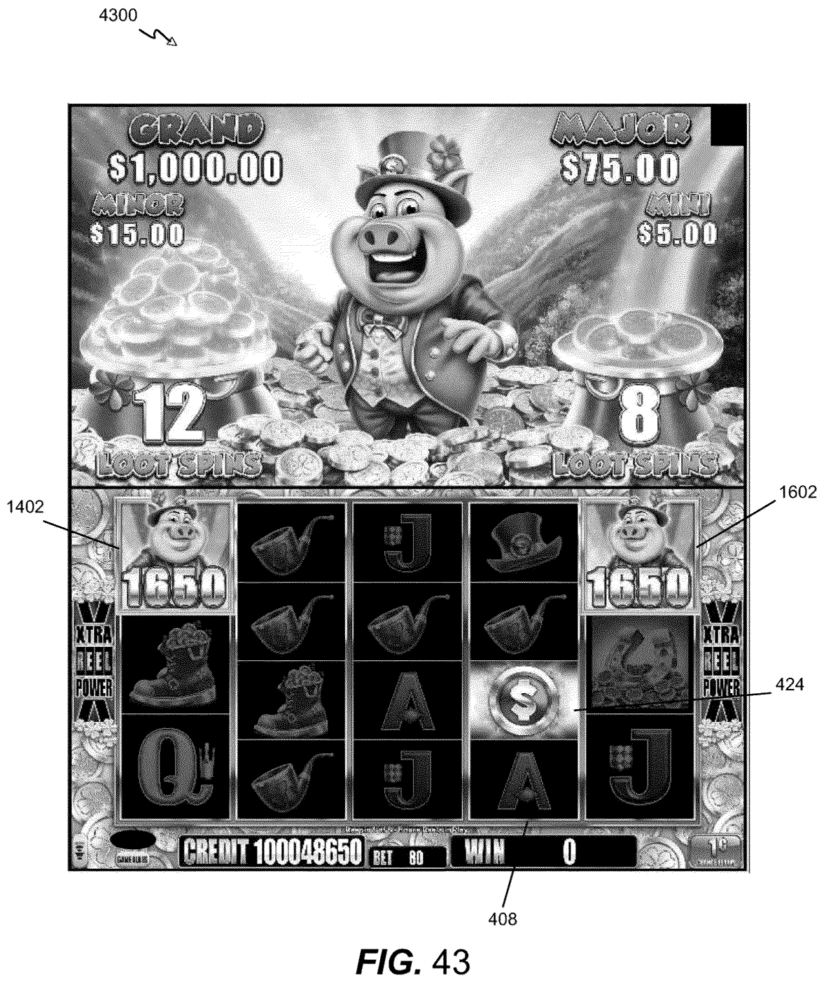

As shown in FIG. 41, a COR symbol 424 is displayed on reel 408. FIG. 42 illustrates another example screenshot and/or interface 4200 of the electronic game with symbol collection shown in FIG. 26, in accordance with the present disclosure where COR symbol values 4202 associated with the COR symbol 424 on reel 408 are shown as being animated between the COR symbol 424 on reel 408 and qualifier symbols 1402, 1602 to illustrate that COR symbol values 4202 will be applied to qualifier symbols 1402, 1602. FIG. 43 illustrates another example screenshot and/or interface 4300 of the electronic game with symbol collection shown in FIG. 26, in accordance with the present disclosure where COR symbol values 4202 have been applied to qualifier symbols 1402, 1602 and the COR symbol 424 on reel 408 has changed to the second display state to indicate that COR symbol values 4202 have been applied to qualifier symbols 1402, 1602.

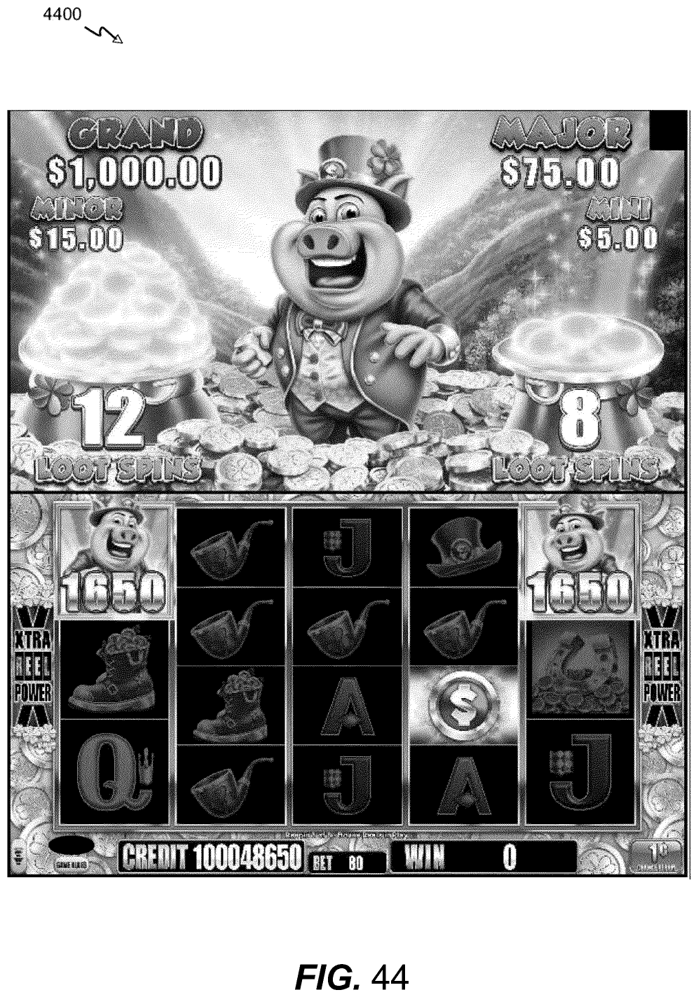

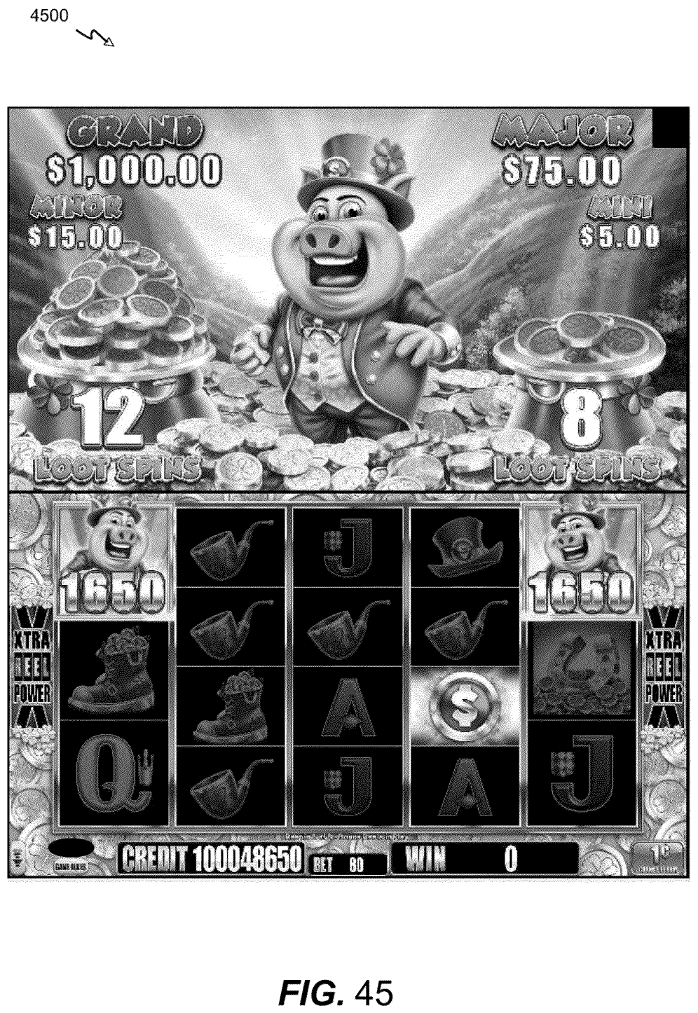

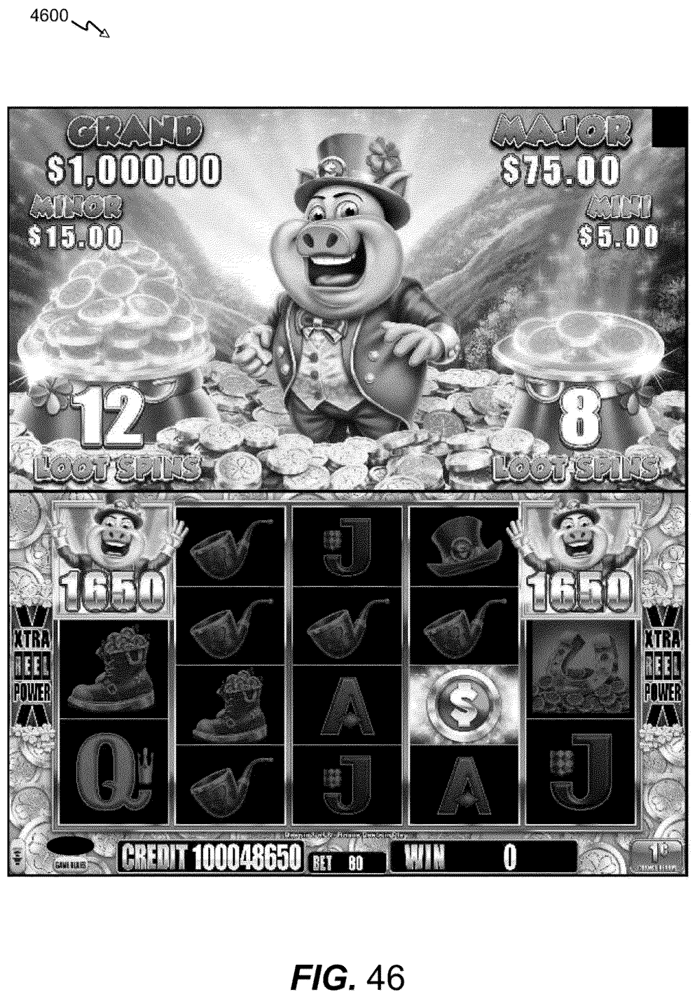

FIG. 44 illustrates another example screenshot and/or interface 4400 of the electronic game with symbol collection shown in FIG. 26, in accordance with the present disclosure after the fifth spin of the feature game. FIG. 45 illustrates another example screenshot and/or interface 4500 of the electronic game with symbol collection shown in FIG. 26, in accordance with the present disclosure after the fifth spin of the feature game. FIG. 46 illustrates another example screenshot and/or interface 4600 of the electronic game with symbol collection shown in FIG. 26, in accordance with the present disclosure after the fifth spin of the feature game.

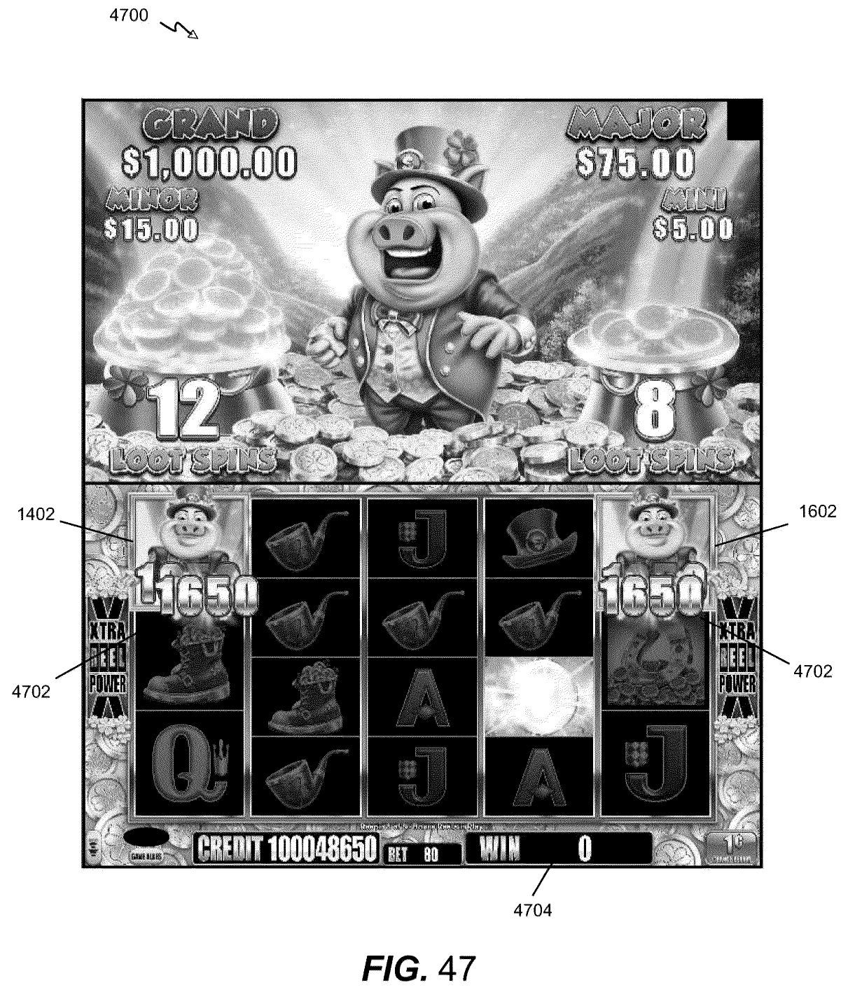

FIG. 47 illustrates another example screenshot and/or interface 4700 of the electronic game with symbol collection shown in FIG. 26, in accordance with the present disclosure where qualifier symbol values 4702 associated with qualifier symbols 1402, 1602 are displayed as being animated between qualifier symbols 1402, 1602 and a win meter 4704 to indicate that the feature game has ended and that qualifier symbol values 4702 are being added to win meter 4704.

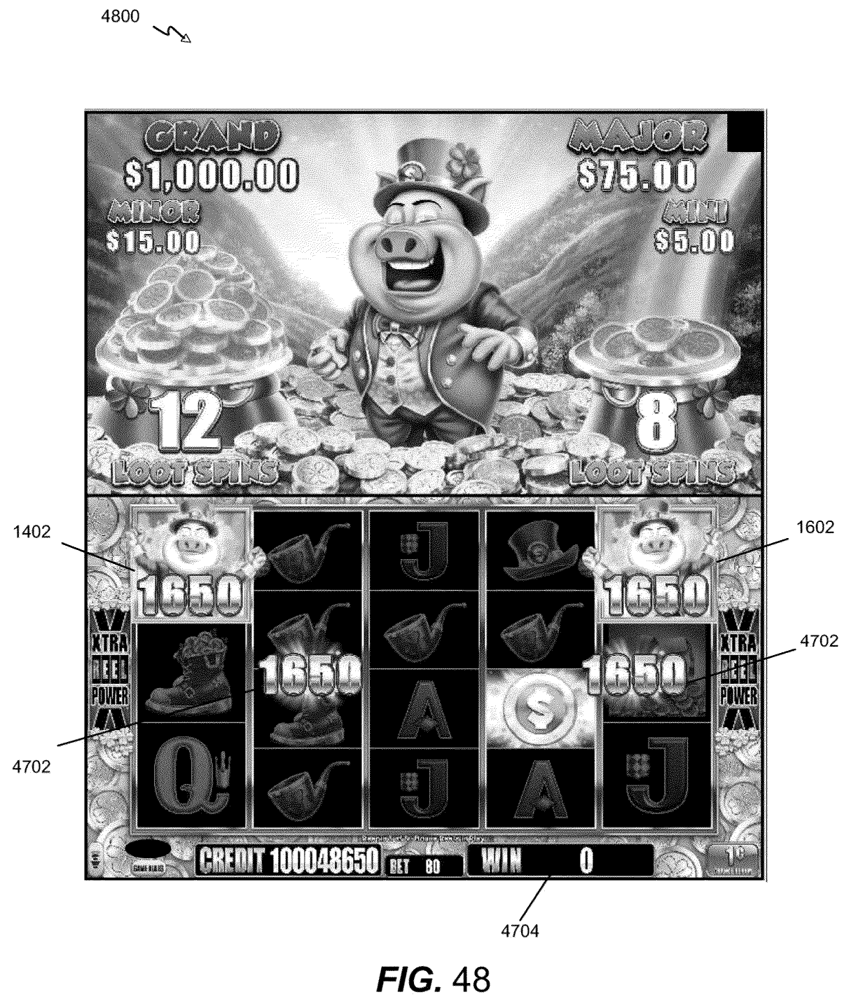

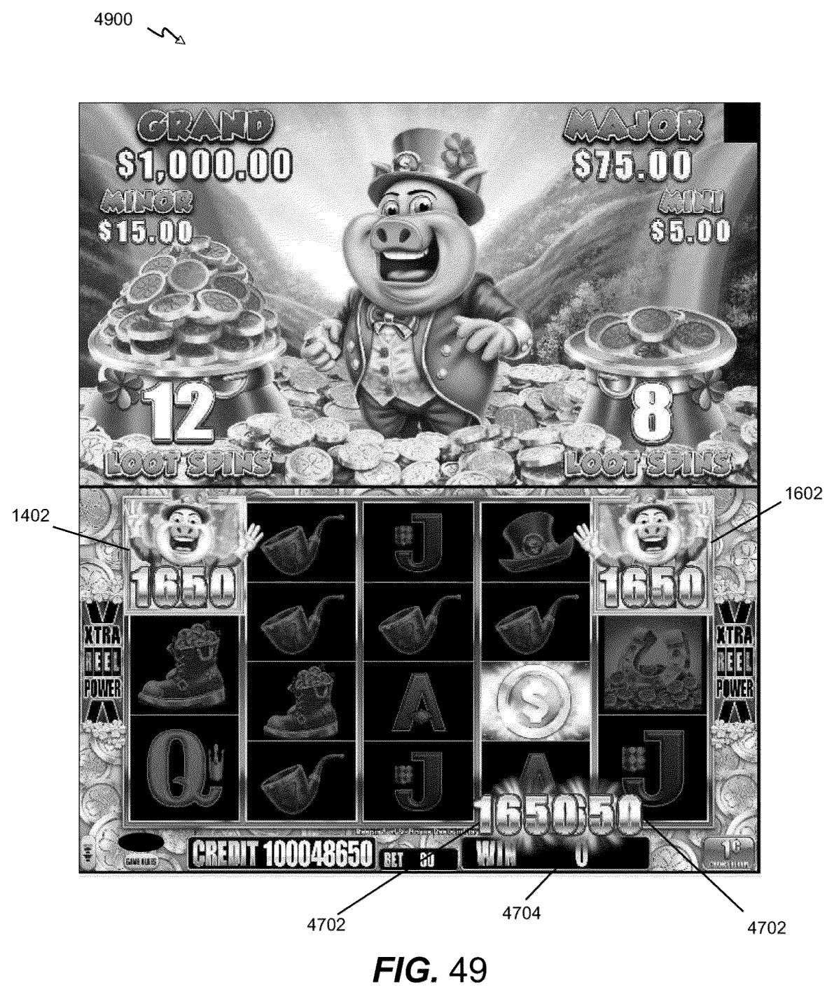

FIG. 48 illustrates another example screenshot and/or interface 4800 of the electronic game with symbol collection shown in FIG. 26, in accordance with the present disclosure where qualifier symbol values 4702 associated with qualifier symbols 1402, 1602 are displayed as being animated between qualifier symbols 1402, 1602 and a win meter 4704 to indicate that the feature game has ended and that qualifier symbol values 4702 are being added to win meter 4704. FIG. 49 illustrates another example screenshot and/or interface 4900 of the electronic game with symbol collection shown in FIG. 26, in accordance with the present disclosure where qualifier symbol values 4702 associated with qualifier symbols 1402, 1602 are displayed as being animated between qualifier symbols 1402, 1602 and a win meter 4704 to indicate that the feature game has ended and that qualifier symbol values 4702 are being added to win meter 4704.

While FIGS. 26-49 illustrate an example embodiment of the feature game described herein, additional embodiments are also envisioned. For instance, during play of the feature game, additional spins (e.g., free spins) may be provided. As an example, similar to play of the base game, a random determination for each play of the feature game may be made as to whether a chance at additional spins will be provided. If additional spins may be provided, an animation may be displayed between any displayed qualifier symbols and one or more of metamorphics 412, 414. Another random determination may be made as to, if additional spins may be provided, whether additional spins and/or how many additional spins will be provided.

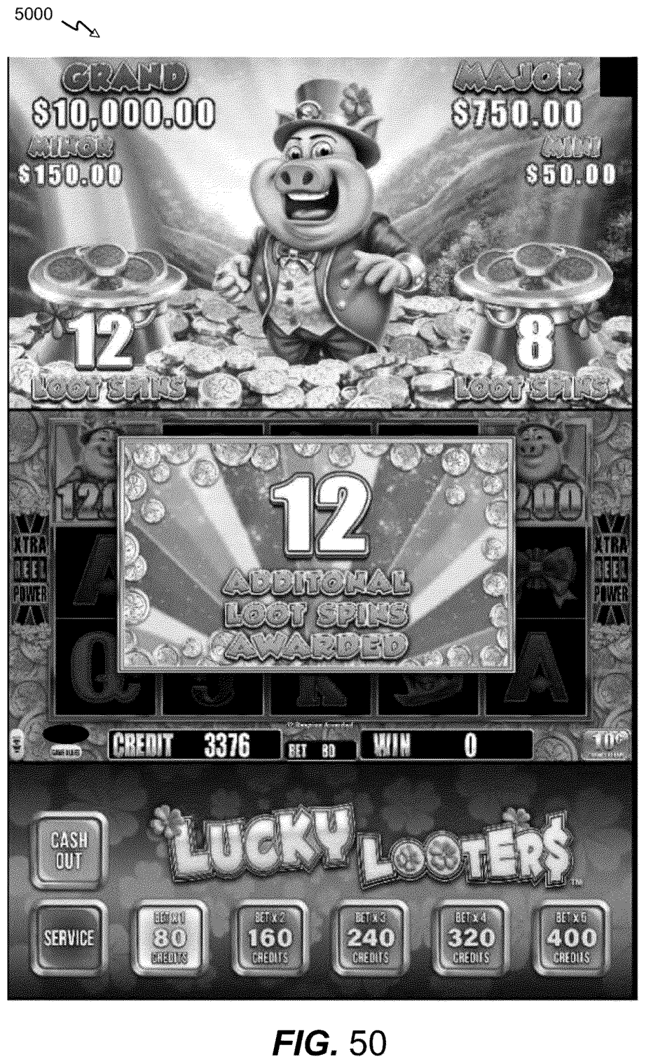

FIG. 50 illustrates an example screenshot and/or interface 5000 of the electronic game with symbol collection shown in FIG. 26, in accordance with the present disclosure where twelve additional spins are provided during play of the feature game.

As another example, additional qualifier symbols may be provided (e.g., on reels 402, 410) during play of the feature game. In the example embodiment, when a new qualifier symbol is displayed, the new qualifier symbol will only accumulate COR symbol values associated with COR symbols displayed during the spin where the new qualifier symbol was initially displayed and any subsequent spins of the feature game (e.g., and not COR symbol values associated with COR symbols displayed during previous spins of the feature game). Thus, when the feature game ends, different qualifier symbols may contribute different values to win meter 4704.

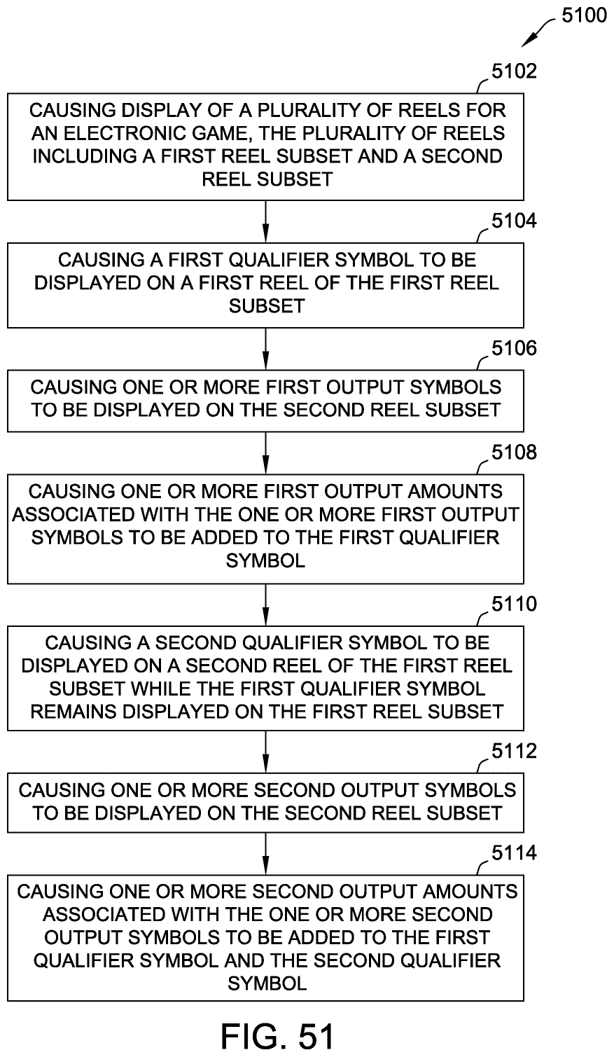

FIG. 51 illustrates an example method 5100 of electronic gaming with symbol collection, in accordance with the present disclosure.

As shown in FIG. 51, method 5100 includes causing 5102 display of a plurality of reels for an electronic game (e.g., reels 402-410), the plurality of reels including a first reel subset where qualifier symbols are eligible to be provided (e.g., reels 402, 410) and a second reel subset where output symbols are eligible to be provided (e.g., reels 404-408).

Method 5100 also includes, for a first play of the electronic game, causing 5104 a first qualifier symbol (e.g., qualifier symbol 1402) to be displayed on a first reel of the first reel subset, causing 5106 one or more first output symbols (e.g., COR symbols 424) to be displayed on the second reel subset, and causing 5108 one or more first output amounts associated with the one or more first output symbols to be added to the first qualifier symbol.

Method 5100 further includes, for a second play of the electronic game, causing 5110 a second qualifier symbol (e.g., qualifier symbol 1602) to be displayed on a second reel of the first reel subset while the first qualifier symbol remains displayed on the first reel subset, causing 5112 one or more second output symbols (e.g., COR symbols 424) to be displayed on the second reel subset, and causing 5114 one or more second output amounts associated with the one or more second output symbols to be added to the first qualifier symbol and the second qualifier symbol.

In some embodiments, method 5100 includes causing display of animations simultaneously between the one or more second output symbols and the first qualifier symbol and the one or more second output symbols and the second qualifier symbol to communicate that the one or more second output amounts are being added to the first qualifier symbol and the second qualifier symbol (e.g., see FIGS. 41-43).

While the disclosure has been described with respect to the figures, it will be appreciated that many modifications and changes may be made by those skilled in the art without departing from the spirit of the disclosure. Any variation and derivation from the above description and figures are included in the scope of the present disclosure as defined by the claims.

What is claimed is:

1. An electronic gaming device comprising:
at least one memory with instructions stored thereon; and
at least one processor in communication with the at least one memory, wherein the instructions, when executed by the at least one processor, cause the at least one processor to:
cause display of a plurality of reels for an electronic game, the plurality of reels comprising a first reel subset where qualifier symbols are eligible to be provided and a second reel subset where output symbols are eligible to be provided;
for a first play of the electronic game:
cause a first qualifier symbol to be displayed on a first reel of the first reel subset;
cause one or more first output symbols to be displayed on the second reel subset; and
cause one or more first output amounts associated with the one or more first output symbols to be added to the first qualifier symbol;
for a second play of the electronic game:
cause a second qualifier symbol to be displayed on a second reel of the first reel subset while the first qualifier symbol remains displayed on the first reel subset;
cause one or more second output symbols to be displayed on the second reel subset; and
cause one or more second output amounts associated with the one or more second output symbols to be added to the first qualifier symbol and the second qualifier symbol.

2. The electronic gaming device of claim 1, wherein the instructions further cause the at least one processor to cause display of an animation between the one or more first output symbols and the first qualifier symbol to communicate that the one or more first output amounts associated with the one or more first output symbols are being added to the first qualifier symbol.

3. The electronic gaming device of claim 1, wherein the instructions further cause the at least one processor to cause display of animations simultaneously between the one or more second output symbols and the first qualifier symbol and the one or more second output symbols and the second qualifier symbol to communicate that the one or more second output amounts are being added to the first qualifier symbol and the second qualifier symbol.

4. The electronic gaming device of claim 1, wherein the first reel subset comprises a leftmost reel of the plurality of reels and a rightmost reel of the plurality of reels.

5. The electronic gaming device of claim 4, wherein the second reel subset comprises reels of the plurality of reels between the leftmost reel and the rightmost reel.

6. The electronic gaming device of claim 1, wherein the instructions further cause the at least one processor to provide the electronic game for a number of plays, the number of plays including the first play and the second play.

7. The electronic gaming device of claim 6, wherein the instructions further cause the at least one processor to randomly determine whether to increase the number of plays in response to at least one of the first qualifier symbol being displayed for the first play or the second qualifier symbol being displayed for the second play.

8. The electronic gaming device of claim 1, wherein the instructions further cause the at least one processor to, for a third play of the electronic game:
cause a third qualifier symbol to be displayed on one of the first reel of the first reel subset or the second reel of the first reel subset while the first qualifier symbol and the second qualifier symbol remain displayed on the first reel subset;
cause one or more third output symbols to be displayed on the second reel subset; and
cause one or more third output amounts associated with the one or more third output symbols to be added to the first qualifier symbol, the second qualifier symbol, and the third qualifier symbol.

9. The electronic gaming device of claim 1, wherein the instructions further cause the at least one processor to, after a last play of the electronic game, cause total output amounts accumulated for the first qualifier symbol and the second qualifier symbol to be provided, the total output amounts including the one or more first output amounts and the one or more second output amounts for the first qualifier symbol and the one or more second output amounts for the second qualifier symbol.

10. At least one non-transitory computer-readable storage medium with instructions stored thereon that, in response to execution by at least one processor, cause the at least one processor to:
cause display of a plurality of reels for an electronic game, the plurality of reels comprising a first reel subset where qualifier symbols are eligible to be provided and a second reel subset where output symbols are eligible to be provided;
for a first play of the electronic game:
cause a first qualifier symbol to be displayed on a first reel of the first reel subset;
cause one or more first output symbols to be displayed on the second reel subset; and
cause one or more first output amounts associated with the one or more first output symbols to be added to the first qualifier symbol;
for a second play of the electronic game:
cause a second qualifier symbol to be displayed on a second reel of the first reel subset while the first qualifier symbol remains displayed on the first reel subset;
cause one or more second output symbols to be displayed on the second reel subset; and
cause one or more second output amounts associated with the one or more second output symbols to be added to the first qualifier symbol and the second qualifier symbol.

11. The at least one non-transitory computer-readable storage medium of claim 10, wherein the instructions further cause the at least one processor to cause display of an animation between the one or more first output symbols and the first qualifier symbol to communicate that the one or more first output amounts associated with the one or more first output symbols are being added to the first qualifier symbol.

12. The at least one non-transitory computer-readable storage medium of claim 10, wherein the instructions further cause the at least one processor to cause display of animations simultaneously between the one or more second output symbols and the first qualifier symbol and the one or more second output symbols and the second qualifier symbol to communicate that the one or more second output amounts are being added to the first qualifier symbol and the second qualifier symbol.

13. The at least one non-transitory computer-readable storage medium of claim 10, wherein the first reel subset comprises a leftmost reel of the plurality of reels and a rightmost reel of the plurality of reels.

14. The at least one non-transitory computer-readable storage medium of claim 13, wherein the second reel subset comprises reels of the plurality of reels between the leftmost reel and the rightmost reel.

15. The at least one non-transitory computer-readable storage medium of claim 10, wherein the instructions further cause the at least one processor to provide the electronic game for a number of plays, the number of plays including the first play and the second play.

16. The at least one non-transitory computer-readable storage medium of claim 15, wherein the instructions further cause the at least one processor to randomly determine whether to increase the number of plays in response to at least one of the first qualifier symbol being displayed for the first play or the second qualifier symbol being displayed for the second play.

17. The at least one non-transitory computer-readable storage medium of claim 10, wherein the instructions further cause the at least one processor to, for a third play of the electronic game:
cause a third qualifier symbol to be displayed on one of the first reel of the first reel subset or the second reel of the first reel subset while the first qualifier symbol and the second qualifier symbol remain displayed on the first reel subset;
cause one or more third output symbols to be displayed on the second reel subset; and
cause one or more third output amounts associated with the one or more third output symbols to be added to the first qualifier symbol, the second qualifier symbol, and the third qualifier symbol.

18. The at least one non-transitory computer-readable storage medium of claim 10, wherein the instructions further cause the at least one processor to, after a last play of the electronic game, cause total output amounts accumulated for the first qualifier symbol and the second qualifier symbol to be provided, the total output amounts including the one or more first output amounts and the one or more second output amounts for the first qualifier symbol and the one or more second output amounts for the second qualifier symbol.

19. A method of electronic gaming implemented by at least one processor in communication with at least one memory, the method comprising:
causing display of a plurality of reels for an electronic game, the plurality of reels comprising a first reel subset where qualifier symbols are eligible to be provided and a second reel subset where output symbols are eligible to be provided;
for a first play of the electronic game:
causing a first qualifier symbol to be displayed on a first reel of the first reel subset;
causing one or more first output symbols to be displayed on the second reel subset; and
causing one or more first output amounts associated with the one or more first output symbols to be added to the first qualifier symbol;
for a second play of the electronic game:
causing a second qualifier symbol to be displayed on a second reel of the first reel subset while the first qualifier symbol remains displayed on the first reel subset;
causing one or more second output symbols to be displayed on the second reel subset; and
causing one or more second output amounts associated with the one or more second output symbols to be added to the first qualifier symbol and the second qualifier symbol.

20. The method of claim 19, further comprising causing display of animations simultaneously between the one or more second output symbols and the first qualifier symbol and the one or more second output symbols and the second qualifier symbol to communicate that the one or more second output amounts are being added to the first qualifier symbol and the second qualifier symbol.
